(19) United States
(12) Patent Application Publication
(10) Pub. No.: US 2016/0242024 A1
(43) Pub. Date: Aug. 18, 2016

(54) PURPOSED DEVICE MANAGEMENT PLATFORM

(71) Applicant: Moki Mobility, Inc., Lehi, UT (US)

(72) Inventors: Thomas H. Karren, Alpine, UT (US); Ty J. Allen, Alpine, UT (US); Jared T. Blake, Eagle Mountain, UT (US); Jared Maxwell, Herriman, UT (US); Kory Calmes, Salt Lake City, UT (US); Jon Sheppard, South Jordan, UT (US)

(21) Appl. No.: 15/141,407

(22) Filed: Apr. 28, 2016

Related U.S. Application Data
(63) Continuation-in-part of application No. 14/204,717, filed on Mar. 11, 2014.
(60) Provisional application No. 62/155,597, filed on May 1, 2015.
(60) Provisional application No. 61/914,203, filed on Dec. 10, 2013.
(60) Provisional application No. 61/790,409, filed on Mar. 15, 2013.

(51) Int. Cl. H04W 8/22; G06F 21/88; G06F 21/62; G06F 21/30; G06F 21/55

(52) U.S. Cl. CPC H04W 8/22; G06F 21/305; G06F 21/554; G06F 21/629; G06F 21/88; G06F 2221/2149; G06F 2221/034

(57) ABSTRACT

A purposed-device management platform monitors a network of mobile devices dedicated to a single purpose. The single purpose may be to function as a point-of-sale terminal at a retail shop or a plurality of retail shops or for other purposes, such as customer service, digital signage security, resource management, testing and an educational function. Each device is monitored by the management platform, which may include a variety of functions and applications to accomplish its single purpose goals. Monitoring functions may include geolocation monitoring and device and application performance statistics and may alert the platform or the local user when a malfunction occurs. Each mobile device and appropriate software may record interactions with customers or potential customers. The platform may perform digital interaction tracking with customers or potential customers via a digital interaction tracking dashboard, which records increasing levels of interaction and interest by persons near each mobile device.

### RELATED APPLICATIONS

This application claims priority to the following provisional application, which is hereby incorporated by reference in its entirety: Prov. Appl. 62/155,597, filed May 1, 2015, and entitled Purposed Device Management Platform. This application also is a continuation-in-part of non-provisional application Ser. No. 14/204,717, filed Mar. 11, 2014, and entitled Device and Settings Management Platform. Non-provisional application Ser. No. 14/204,717 claims the benefit of provisional application 61/914,203, filed Dec. 10, 2013, entitled Device and Settings Management Platform, and also claims the benefit of provisional application 61/790,409, filed Mar. 15, 2013, entitled Purposed-Device Management Platform. All of the above patent applications are hereby incorporated by reference in their entirety.

### BACKGROUND

1. Field of the Invention

The methods and systems disclosed herein generally relate to the management of mobile devices and particularly to methods and systems for assigning, controlling, and monitoring the intended purpose and functional parameters permitted for a plurality of devices within an enterprise deployment, including the functional parameters and settings of applications running on such plurality of devices within the enterprise deployment.

2. Description of the Related Art

Organizations around the world are taking advantage of new computing technologies, including tablet computers and other mobile devices, such as smart phones, to augment or replace existing commercial functions, including but not limited to facilitating and recording point-of-sale consumer transactions. The deployment of such devices within an enterprise, such as a retail store, often requires that the devices have a defined purpose and a set of limitations placed on the devices' functionality that restricts the usage of the device to that defined purpose. For example, a retail store may want to deploy table computers, such as iPads or Android-based tablets, for use in processing customer purchases, including but not limited to credit card-based transactions.

The retailer may also want these devices to be restricted from other activities, such as web browsing, SMS, or email functions. While organizations currently have tools for deploying and registering mobile devices for employees, such as company cellular phones or laptop computers, the registration and deployment of such devices are often based largely on personnel-related parameters pertaining to the employee that will be using the device and the credentials and permissions associated with that employee, rather than an intended purpose for the mobile device that is to be deployed, where the purpose of the device is fixed irrespective of the party utilizing the device.

Therefore, there exists a need for a system and method for assigning, controlling, and monitoring the intended purposes and functional parameters that are permitted for a plurality of general purpose devices within an enterprise deployment, including the functional parameters and settings of applications running on such plurality of devices within a multiple device deployment, such as an enterprise deployment.

### SUMMARY

Provided herein are methods and systems for remotely restricting the functionality of a mobile device to an intended purpose. The method may include a computer having a non-transitory computer readable medium having stored thereon instructions which, when executed by a processor of the computer, causes the processor to perform the steps of registering the mobile device with a Purposed-Device Management Platform, uploading an application to the mobile device wherein the application uploaded conforms to the purpose, determining the settings of the application, monitoring the settings of the application, monitoring the usage of the application for conformance to the purpose wherein detecting nonconforming usage prompts an alert and wherein an alert is generated to the platform, and taking an action based on the alert received. Provided are embodiments wherein the mobile device is a plurality of mobile devices. Also provided are embodiments wherein the mobile device is a tablet computer. Further provided are embodiments wherein the mobile device is a phone. Provided are embodiments wherein the mobile device is a handheld computer. Additionally, provided are embodiments wherein the action taken based upon detecting a usage that is nonconforming to the intended purpose is to shut down the application, to lock the device, to return the device to factory settings, or to perform some other action.

Further disclosed are embodiments of a system for remotely restricting the functionality of a mobile device to an intended purpose. The system may include a computer having a processor, a purposed device management platform implemented by the computer and a mobile device in communication with the computer via the purposed device management platform wherein the communication comprises registering the mobile device with the Purposed-Device Management Platform, uploading an application to the mobile device wherein the application uploaded conforms to the purpose, monitoring the usage and settings for conformance to the purpose, wherein nonconforming usage or settings prompts an alert to the purposed device management platform, and taking action based on the alert received. Provided are embodiments wherein the mobile device is a plurality of mobile devices. Also provided are embodiments wherein the mobile device is a tablet computer. Further provided are embodiments wherein the mobile device is a phone. Provided are embodiments wherein the mobile device is a handheld computer. Additionally, provided are embodiments wherein the action taken based upon detecting a usage that is nonconforming to the intended purpose is to shut down the application, to lock the device, to return the device to factory settings, or to perform some other action.

Further disclosed is a Purposed-Device Management Platform (PDMP). The PDMP may include a mobile device management module for management of a mobile device, an application distribution module for distribution of applications, an applications settings management module, an application environment monitoring and an endpoint security service module. Provided are embodiments wherein the mobile device is a plurality of mobile devices. Also provided are embodiments wherein the mobile device is a tablet computer. Further provided are embodiments wherein the mobile device is a phone. Provided are embodiments wherein the mobile device is a handheld computer. Further provided are embodiments wherein the mobile device management module manages inventory, status, profiles, and security polices of a mobile device.

Also provided are embodiments wherein the applications settings management model is programmed to change application settings from a single location and apply the settings to applications on the mobile device. Also provided are embodiments wherein the application environment monitoring module determines if an application is running properly. Provided are embodiments wherein the application environment monitoring module checks network access. Provided are embodiments wherein the application environment monitoring module checks power levels. Also provided are embodiments, wherein the application environment monitoring module takes screenshots from the application. Additionally, provided are embodiments, wherein the application environment monitoring module examines devices logs. Provided are embodiments, wherein the endpoint security service module actively scans and monitors for security related issues. Also provided are embodiments, wherein the endpoint security service module scans for issues such as purposed-device jailbreak status, rooting status, application authenticity, location, custom app alerts and notifications.

Further disclosed is a cloud-based platform for device management. The platform may include a remote device manager, a remote device deployment monitor, a remote device configuration monitor, and a remote device performance monitor. Provided are embodiments, wherein the remote device may be a mobile device. Provided are embodiments wherein the mobile device is a plurality of mobile devices. Also provided are embodiments wherein the mobile device is a tablet computer. Provided are embodiments wherein the mobile device is a phone. Further provided are embodiments wherein the mobile device is a handheld computer. Also provided are embodiments wherein the remote device manager may lock down the remote device. Provided are embodiments wherein the remote device manager may secure the remote device.

Further disclosed is a platform for purposed devices deployed in commercial settings, including, without limitation, retain environments. The platform may include a settings adjustment module wherein the module adjusts the settings of a mobile device only when the mobile device is in communication with a designated computer, a mobile device connections module wherein the connections module allows a mobile device only to connect to a designated network, a mobile device configurations module, and a mobile device management module. Provided are embodiments wherein the mobile device connections module further only allows a mobile device to connect to a designated network when connectivity is lost. Additionally, provided are embodiments wherein the mobile device is a plurality of mobile devices. Also provided are embodiments wherein the mobile device is a tablet computer. Further provided are embodiments wherein the mobile device is a phone. Provided are embodiments wherein the mobile device is a handheld computer. Provided are embodiments wherein the mobile device configurations module allows a user to generate custom OS configurations. Also provided are embodiments wherein the mobile device configurations module automatically applies the custom OS configurations to the plurality of mobile devices. Provided are embodiments wherein the device management module may allow a user to put the mobile device into supervisor mode. Further provided are embodiments wherein supervisor mode comprises app-lock functionality and global proxy configuration functionality.

One embodiment of the present disclosure is a method for remotely restricting functionality of a plurality of mobile devices to an intended purpose using a purposed-device management platform. The method includes restricting functionality of a plurality of general purpose mobile devices to an intended purpose using a purposed-device management platform. The method includes a step of registering the plurality of mobile devices with the purposed-device management platform and uploading an application to the each of the plurality of mobile devices wherein the application conforms to the intended purpose. At the purposed-device management platform, the method includes steps of determining settings for the mobile device for the application, wherein the settings are based at least in part on the intended purpose. The method also includes monitoring the settings and monitoring usage of the application for conformance to the intended purpose, and if a nonconforming usage occurs, prompting an alert and taking an action based on the alert. In one embodiment, the method further comprises monitoring each of the plurality of general purpose mobile devices for at least one of: geolocation; operating system integrity; operation system configuration; application integrity; application configuration; and security of at least one attached peripheral device.

In one embodiment, the step of uploading the application to each of the plurality of mobile devices is accomplished with an application settings management (ASM) module that determines the settings for the application on each of the plurality of mobile devices and does not require individual settings for each device of the plurality of mobile devices. In one embodiment, the settings are applied to a network of the mobile devices. The mobile devices are selected from the group consisting of a smart phone, a handheld computer, a tablet computer, a pad-type computer and a portable computer. In embodiments, the intended purpose is selected from the group consisting of a point of sale terminal function, a kiosk function, a customer service function, a digital signage function, a resource management function, a testing function and an educational function. The method may further include uploading the application and the settings to a cloud service for downloading by a device that is registered with the purposed-device management platform. In one embodiment, the action taken is selected from the group consisting of shutting down the application, blocking use of the application, blocking use of another application, alerting a manager of the individual using the mobile device, locking the mobile device, restoring the device to a correct setting, and returning the device to a factory setting or a default setting.

Another embodiment of the present disclosure is a method for remotely restricting functionality of a mobile device, such as a general purpose mobile device, to an intended purpose using a purposed-device management platform. The platform comprises a computer having a non-transitory computer readable medium having stored thereon instructions which, when executed by at least one processor of the computer, causes the at least one processor to perform the steps of registering the mobile device with the purposed-device management platform, uploading an application to the mobile device wherein the application conforms to the intended purpose and determining settings for the mobile device for the application, wherein the settings are based at least in part on the intended purpose. The method also includes steps of monitoring the settings and monitoring usage of the application for conformance to the intended purpose, and if a nonconforming usage occurs, prompting an alert and taking an action based on the alert.

In one embodiment, the settings are applied to a network of the mobile devices. The mobile device is selected from the group consisting of a smart phone, a handheld computer, a tablet computer, a pad-type computer and a portable computer. In one embodiment, the intended purpose is selected from the group consisting of a point of sale terminal function, a kiosk function, a customer service function, a digital signage function, a resource management function, a testing function and an educational function. In one embodiment, the method further includes uploading the application and the settings to a cloud service for downloading by a device that is registered with the purposed-device management platform.

Another embodiment of the present disclosure is a system for operating a collection, such as a network, of mobile devices for an intended purpose. The system includes a computer having a processor, a purposed-device management platform implemented by the computer and a plurality of mobile devices in communication with the computer via the purposed device management platform. The communication includes registering the mobile device with the purposed device management platform, uploading an application to the mobile device wherein the application uploaded conforms to the purpose, and monitoring the usage and settings for conformance to the intended purpose, wherein nonconforming usage or settings prompts an alert to the purposed device management platform.

In one embodiment, the intended purpose of the device is usage as a point of sale terminal function in the system. In one embodiment, the mobile devices are selected from the group consisting of a smart phone, a portable computer, a pad-type computer, a tablet computer and a handheld computer. In one embodiment, the intended purpose is selected from the group consisting of a customer service function, a kiosk function, a digital signage function, a resource management function, a testing function and an educational function. In one embodiment, the purposed device management platform further comprises an application setting management (ASM) module adapted to monitor a location of each of the plurality of mobile devices. In one embodiment, the purposed device management platform further includes an endpoint security service module adapted to actively monitor each of the plurality of mobile devices for at least one of: geolocation; operating system integrity; operation system configuration; application integrity; application configuration; and security of at least one attached peripheral device. In one embodiment, the purposed-device management platform further comprises at least one module selected from the group consisting of: a mobile device management (MDM) module; an application distribution module (ADM); an applications setting management (ASM) module; an application environment monitoring (AEM) module; and an endpoint security service (ESS).

Further disclosed is a remote mobile device support method and system. In embodiments, the remote mobile device support method and system may detect a mobile device and at least one software application on the mobile device, within a network, wherein the detection occurs within a distributed computing environment that includes computing and storage facilities that are remote to the mobile device. Application operations information that is associated with the performance of the application may be monitored and an administrator enabled to remotely view the screen of the mobile device and record a session with a user of the mobile device. The application operations data, and the recorded session, may be logged, stored and uploaded to the distributed computing environment, and at least one of a pre-defined or developer-defined command be sent to the software application from the distributed computing environment based at least in part on the application operations data. Applications operations data may include, but is not limited to network calls made by the software application, operating statistics for the software application, performance statistics for the software application, data access calls made by the software application, queries made by the software application, or some other type of application operations data.

Further disclosed is a method and system for operating a network of mobile devices for an intended purpose, the system comprising: a computer having a processor, a purposed-device management platform implemented by the computer, and a plurality of mobile devices in communication with the computer via the purposed-device management platform, wherein each of the plurality of mobile devices comprises. An application for digital interaction with a customer of an organization operating the purposed device may also be provided, and an application for digital interaction tracking with the customer of the organization operating the purposed-device management platform.

In embodiments, the application for digital interaction with the customer may be adapted for presenting options for a good or a service to the customer of the organization operating the purposed-device management platform.

In embodiments, each of the plurality of mobile devices may further comprise a digital camera for capturing an image of the customer and facial recognition software for interpreting the image of the customer.

In embodiments, the application for digital interaction with the customer and the facial recognition software may be adapted for recognizing a facial image of the customer, a length of a time period the customer faces the digital camera, a touching of a feature of one of the plurality of mobile devices and an interpretation of interest or non-interest by the customer.

In embodiments, the purposed-device management platform may include non-transitory instructions for each of the plurality of mobile devices for registering the mobile device with the purposed device management platform, uploading at least one additional application to the mobile device wherein the application uploaded conforms to the intended purpose, and monitoring the usage and settings for conformance to the intended purpose, wherein nonconforming usage or settings prompts an alert to the purposed-device management platform.

In embodiments, each of the plurality of mobile devices further comprises an application for digital interaction tracking with a customer or potential customer of an organization operating the purposed device and an application for digital interaction tracking with the customer or potential customer of the organization operating the purposed-device management platform. In embodiments, the application for digital interaction with the customer or potential customer is adapted for presenting options for a good or a service to the customer or potential customer of the organization operating the purposed-device management platform. In embodiments, each of the plurality of mobile devices in communication with the computer via the purposed-device management platform further comprises a digital camera for capturing an image of the customer or potential customer and facial recognition software for interpreting the image of the customer or potential customer.

In embodiments, the application for digital interaction tracking with the customer or potential customer and the facial recognition software are adapted for recognizing a facial image of the customer or potential customer, a length of time the customer or potential customer faces the digital camera, a touching of a feature of one of the plurality of mobile devices and an interpretation of interest or non-interest by the customer or potential customers. In embodiments, the application for digital interaction tracking is adapted to automatically tabulate a quantity of interactive sessions with customers or potential customers of the organization operating the purposed-device management platform. In embodiments, the application for digital interaction tracking is adapted to automatically tabulate a quantity of impressions with customers or potential customers, a quantity of views from the customers or potential customers with impressions, a conversion rate of the quantity of impressions to the quantity of views, a quantity of digital interactions with customers or potential customers with views and a conversion rate of the quantity of views to the quantity of digital interactions.

These and other systems, methods, objects, features, and advantages of the present disclosure will be apparent to those skilled in the art from the following detailed description of the preferred embodiment and the drawings. All documents mentioned herein are hereby incorporated in their entirety by reference.

### BRIEF DESCRIPTION OF THE FIGURES

The disclosure and the following detailed description of certain embodiments thereof may be understood by reference to the following figures:

FIG. 1 depicts management modules of the Purposed-Device Management Platform.

FIG. 2 depicts a Web Dashboard associated with the Purposed-Device Management Platform that may be used to configure devices.

FIG. 3 depicts a simplified overview of the Purposed-Device Management Platform functionality.

FIG. 4 depicts a simplified overview of the system architecture of the Purposed-Device Management Platform.

FIG. 5 depicts the Device Management module of the Purposed-Device Management Platform.

FIG. 6 depicts the App Distribution module of the Purposed-Device Management Platform.

FIG. 7 depicts the App Settings Management module of the Purposed-Device Management Platform.

FIG. 8 depicts the App Environment Monitoring module of the Purposed-Device Management Platform.

FIG. 9 depicts the Web Dashboard and mobile SDK of the Purposed-Device Management Platform.

FIG. 10 depicts a simplified embodiment of the tenant-app association and related metadata.

FIG. 11 depicts an example of the display interface for obtaining the enrollment code.

FIG. 12 depicts an example of the prompt display.

FIG. 13 depicts an example of a display interface associated with a method for registering a device with MDM.

FIG. 14 depicts an example of a block diagram for defining the app setting hierarchy.

FIG. 15 depicts an example of settings hierarchy for the GuestGuide application.

FIG. 16 depicts a simplified embodiment of a session in which remote support is provided to a user of a mobile device.

FIG. 17 depicts a simplified embodiment of the Digital Interaction Tracking Dashboard, showing the relation among the impressions, views and interactions taking place on a purposed device.

FIG. 18 depicts a simplified embodiment of the Digital Interaction Tracking Dashboard, showing the aggregated impressions, views and interactions taking place on a purposed device or plurality of purposed devices, and their associated durations and conversion rates.

FIG. 19 depicts a simplified embodiment of the Digital Interaction Tracking Dashboard, showing the aggregated impressions, views and interactions taking place on a purposed device or plurality of purposed devices, and their associated durations and conversion rates presented with graphing of historical usage data.

### DETAILED DESCRIPTION

A handheld computing device, such as a tablet computer or smart phone, may be used for a variety of personal and business tasks. A single tablet computer user may be able to perform a plurality of tasks using the tablet computer. Alternatively, a special purpose tablet, hereinafter referred to as a purposed-tablet, or more generally a purposed-device, may be used for performing a defined set of tasks for a plurality of users. The present disclosure discloses methods and systems for monitoring, managing, registering and updating such purposed-devices, examples of which may include, but are not limited to, devices for processing point-of-sale (POS) transactions, customer service functions, digital signage, resource management, education, or some other functionality. The purposed-device, as disclosed herein, may include a plurality of applications, hereinafter referred to as “apps” that may be used to perform specific functions based on the defined functionality of the purposed-device (such as a tablet computer).

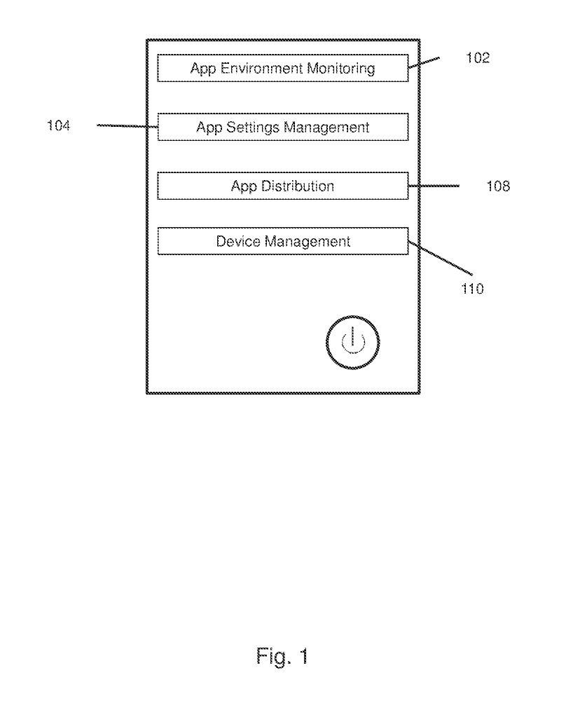

In an embodiment, the present disclosure may include systems and methods for enabling remote application and device management for purposed-devices, as described herein. The remote application and device management solutions may be implemented by a purposed-device PDMP. The purposed applications (“apps”) may have special requirements, or limitations, that may be different from other applications that are accessed using a general purpose mobile device, such as a tablet, for various purposes, such as entertainment, information, communication, or the like, in a relatively unrestricted way. Also, the remote application and device management solutions for the purposed apps may need to be consistently deployed across dozens, hundreds, or even thousands of locations. Thus, the solutions may need to be centrally managed based on usage requirements (e.g., complying with specific requirements for handling information required to enable financial transactions in a secure way), limitations on usage, regulatory requirements (e.g., regulations relating to handling of customer data, such as CVV and other credit card information, privacy regulations, and the like), enterprise policies, or other policies. Referring to FIG. 1 to meet such special demands of purposed-device solutions, the Purposed-Device Management Platform (PDMP) of the present disclosure may include at least five primary modules, a Mobile Device management (MDM) 110 module for managing inventory, status, profiles, and security policies across a large set of devices, an Application Distribution Module (ADM) 108, an Applications Settings Management (ASM) 104 module for changing application settings from a single location and applying to apps on devices as needed, an Application Environment Monitoring (AEM) 102 module for determining if an app is running properly and to check network access, power levels, see device logs, and take screen shots from the app, and an Endpoint Security Service (ESS) module for active scanning and monitoring of security related issues such as purposed-device jailbreak status, rooting status, application authenticity, location, custom app alerts and notifications. The PDMP may enable building custom applications to enhance user experience as part of the remote app and device management solution. Additionally, enabling an app to work with the PDMP may allow centralization of the management of the user experience being delivered with the purposed-app and/or purposed-device.

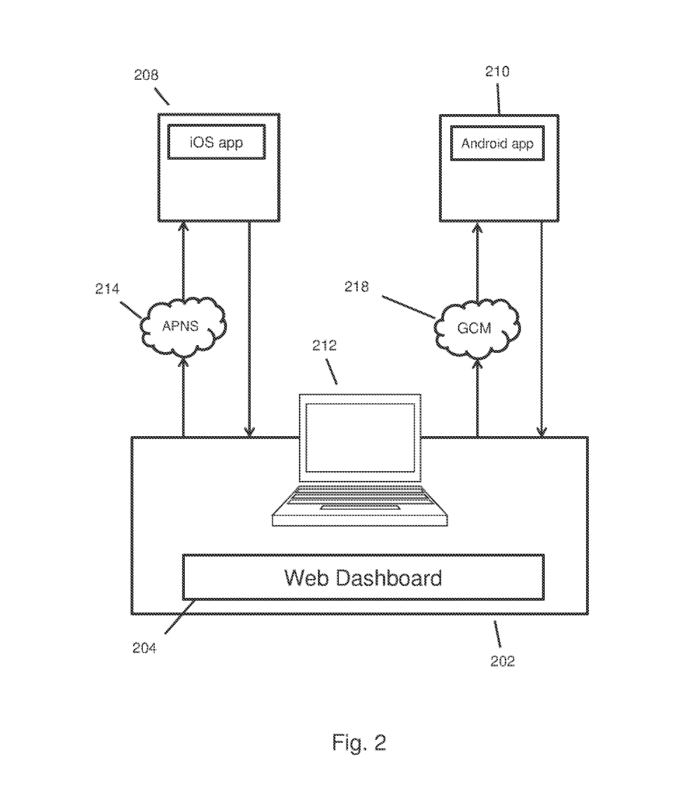

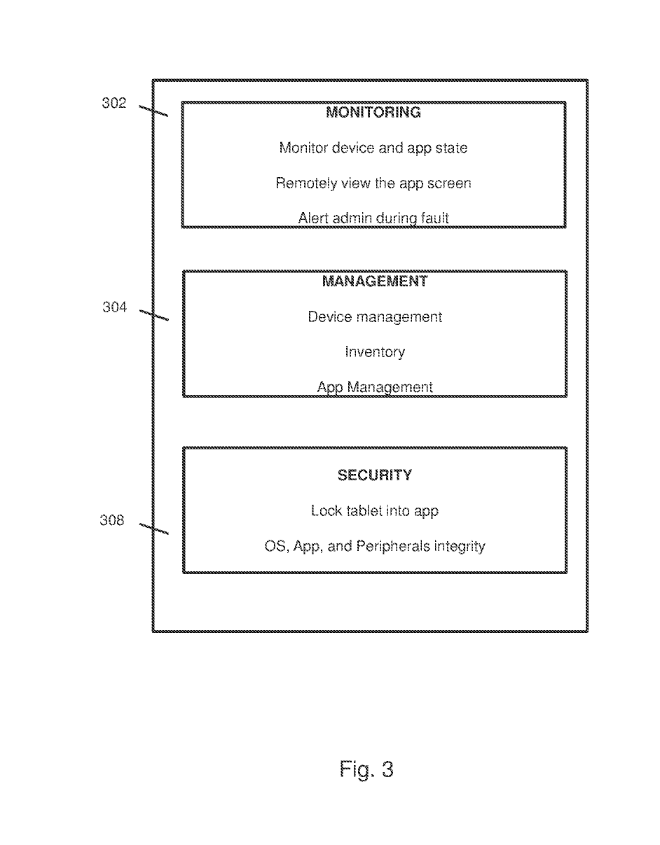

Referring to FIG. 2, in embodiments, the PDMP systems and methods disclosed herein may be deployed as a purposed-device configurator as well as a purposed-device PDMP and system. For example, the PDMP may be used to configure and manage iOS 208 and/or Android-based tablet computers 210. In embodiments, the platform system may include a computer network 202 associated with client computers 212 and a web dashboard 204 which may comprise a cloud-based mobile device management and monitoring platform 214; 218 designed for single-purpose device deployments. As summarized in FIG. 3, the PDMP may include a configurator and system that may enable solutions for deploying, managing 304 and monitoring 302, including security monitoring 306, of purposed devices that are deployed in commercial settings. In embodiments, the Apple Configurator and system may be used to provision and/or update device images and initial settings when a device is plugged into a designated computer 212. Additionally, devices may be configured to use only preferred networks and reconnect to only certain networks if connectivity is lost. In embodiments, a user may implement the configurator to automatically apply custom OS configurations to every device that the user plugs in. The configurator may be used to put the device into a supervisor mode that unlocks several management features and restrictions, such as, but not limited to, app-lock and global proxy configuration. When used in combination with a configurator, the PDMP enables centralized and over the air control of app-lock profiles and global proxy configuration. The app-lock profile can be used with the PDMP to push configuration to the purposed-device that locks the device to work run in a mode where the purposed application is the only active application. This makes it so that the device effectively will only run the purposed application which secures access to other apps and OS features.

Similarly, the methods and systems of the present disclosure may be used to provide an app-lock type functionality in Android platform devices. In the Android platform embodiment, the PDMP functionality may create a customized desktop view using ASM settings for desktop control, which allows the creation of a virtual desktop experience. For example, rather locking a device to one specific app (which may also be done), the PDMP may also provide access to one or more purposed apps, and hide the rest of the apps on the device, as well as any local settings that are not desired to be displayed.

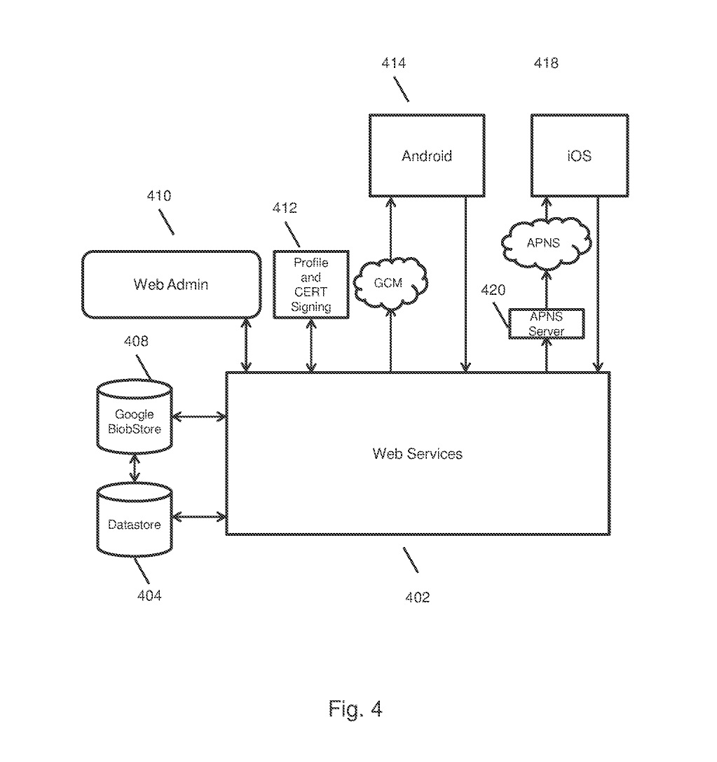

Referring to FIG. 4, in embodiments, the platform system may be configured to operate on various operating systems 414, 418. In a non-limiting example, the platform system architecture may enable provisioning of web services 402 and comprise a primary web interface, web administration 410, profile and CERT signing 412 and data and cloud service API's hosted and stored on, for example, Google App Engine, Google Biob Store 408, Google High Replication DataStore, or some other platform or datastore 404. Communication may take place over standard HTTPS (port 443) except for APNS, GCM and C2DM. In embodiments, APNS and APNS Server 420 may use port 5223, while GCM may use ports 5228, 5229, and 5230 and C2DM may be used as well.

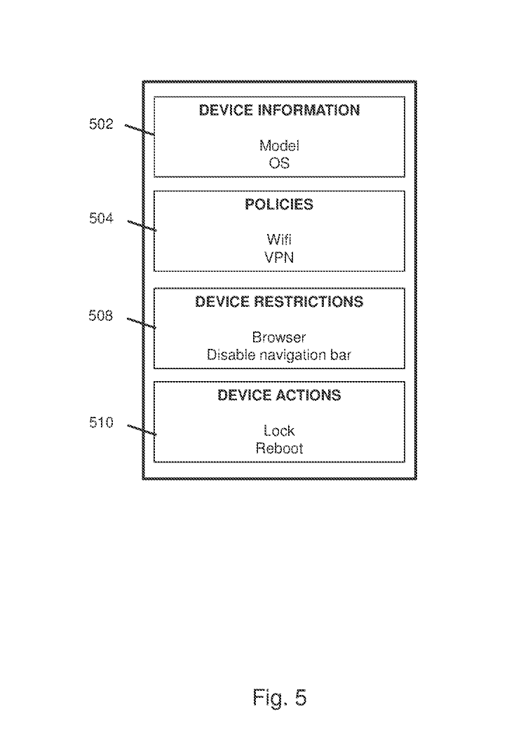

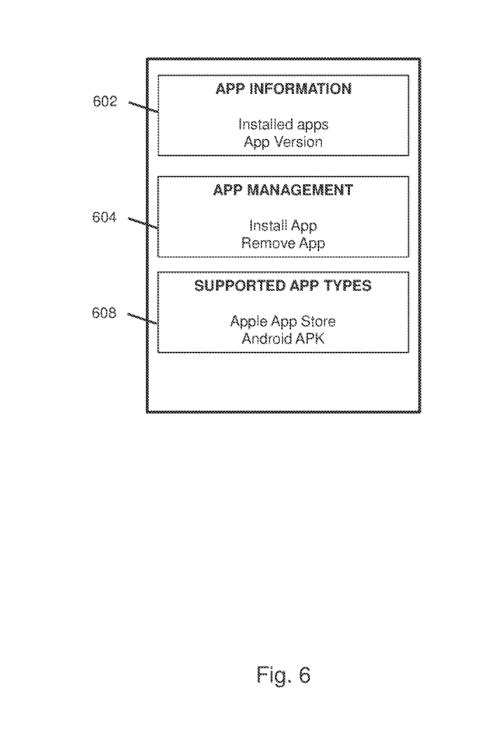

Referring to FIGS. 5 and 6, in embodiments, the PDMP systems and methods disclosed herein may be deployed as a cloud-based platform for app distribution, remote app settings management, device configurations, app monitoring and endpoint security monitoring on communication devices. In embodiments, the PDMP may support the management of thousands of devices (e.g., per enterprise) comprising features for device management and monitoring that streamline deployment, manage device configurations over-the-air and monitor app performance and connectivity. Management of purposed devices using the PDMP, as described herein, may be based at least in part on device information 502, policies (e.g., enterprise policies and protocols) 504, device restrictions 508, device actions 510, or some other device-related characteristic or purpose. Using these features, including but not limited to data relating to application information 602 associated with applications running on a device or plurality of devices, application management protocols 604, supported applications types enabled by the subject devices, the devices managed by the PDMP may be remotely locked down, configured, monitored and secured for use as a reliable single-purpose platform for managing a fleet of communication devices.

The PDMP may comprise an Internet kiosk solution leveraging MDM for remote device and app management, optionally including credit card swipe abilities. The platform may comprise an end-user facing directory of apps and content to distribute enterprise or third party apps to users or let users self-select from approved corporate apps.

In embodiments, the PDMP may allow a user to integrate remote management for specific app settings on a device or gather data on app performance by accessing platform features such as, but not limited to, Application Settings Management (ASM), or Application Environment Monitoring (AEM).

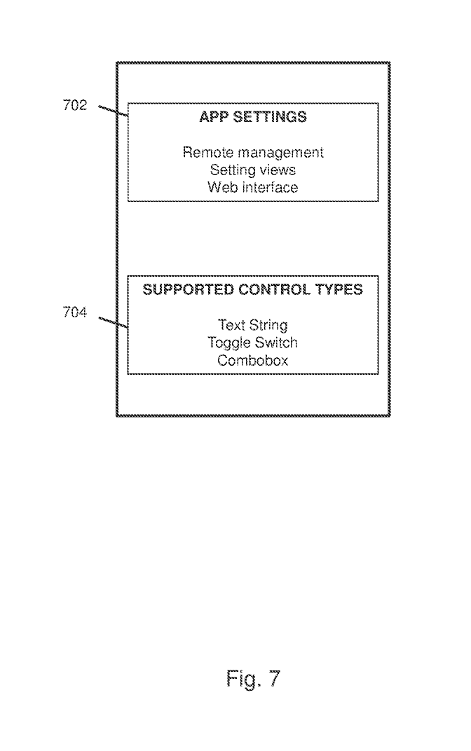

Referring to FIG. 7, in embodiments, the PDMP may comprise an App Settings Management module (ASM) 702 that may enable a mobile application to register its settings with the PDMP for cloud-based management and manage the associated supported control types 704. The ASM may enable developers to leverage the PDMP system for effective cloud-based management of settings in their applications. Developers may be able to create, for example, a partner application in the PDMP and upload their settings criteria or schema for their application. The mobile application may be provided to end users, such as, but not limited to, deploying the app in the iOS store, and the partner application may be deployed to any tenant in the platform system. ISV's and their customers may then be able to do both device and app settings management to enrolled devices and applications using the PDMP.

In embodiments, ASM may enable remote management for application settings in a device, such as, but not limited to, a tablet implementing iOS or Android. In embodiments, app settings may be defined inside an app, and sent to a server upon installation and enrollment of the app on a purposed-device. Device settings may then be managed at the device or through the PDMP web dashboard. Developers may have control over the visibility of individual controls, marking them visible within the web dashboard only, device only or both. In embodiments, ASM may be deployed to manage settings of installed applications on a device, in contrast to managing the actual device itself. In embodiments, the PDMP may include an ASM Client Library, which may be a code library that an application developer includes and integrates with a mobile application at the time of development. In embodiments, the PDMP may comprise an ASM Cloud Service, which may be a cloud-based ASM registration and settings synchronization service that works with mobile applications that use the ASM Client Library. Functional components of the cloud service may include, but are not limited to, providing partner and application account management, settings synchronization, or requiring server/GUI elements. In embodiments, the ASM may comprise an APNS service for iOS, and GCM or C2DM for Android, which may use the ISV's or application's APNS certificate, and may also be implemented to function in AWS. In embodiments, the PDMP may comprise a web based admin (ASM Web Admin) console that allows IT managers and developers to view, create and manage application settings on one or more devices. In embodiments, the PDMP may comprise a remote mobile device notification system hosted by, or compatible with, either iOS or Android devices, or other mobile operating system environments. In embodiments, the PDMP may comprise capabilities to connect to other systems via the Internet, or other similar cloud capabilities. In embodiments, the PDMP may reference devices or applications within its system via an enrollment code. In embodiments, the PDMP may comprise a set of managed settings, which refer to a subset of the application settings, which are to be centrally managed by the PDMP. In embodiments, the PDMP may comprise features such as a reference to a special code or managed system annotation that is placed in the settings name by the developer in order to specify that the setting is eligible for centralized management by the ASM. In embodiments, settings may be implemented as configurations, which may then be applied to a single or a plurality of devices. In embodiments, using ASM, developers may expose settings directly inside the app or outside of the app in general preference areas, following general personal mobile standards. Supported controls may include, but are not limited to: text fields, toggle switches, sliders, combo box, list specifiers and groups.

In embodiments, an application using an ASM Client Library, as described herein, may be installed on a purposed-device by an IT administrator, or in some cases by a device user. This may be done through the PDMP's MDM or other means known to the art. Once the application is installed, it may be registered with the ASM system using an enrollment code. Once the enrollment code is processed by the application, the application may then ‘register’ with the ASM Cloud Service.

Once registration is complete, the application may then scan the settings on the local device and create a schema or settings specification to send to the ASM Service. In embodiments, this schema may determine the settings configuration or list of possible settings that can be managed by the PDMP on the device. This is a process of finding the settings which have been marked and creating a schema file that represents the settings details for this application. The application may also check with the PDMP to see if there are settings in the system that need to be applied to the device. If so, they may be downloaded to the device and applied. If not, the device may then upload its default settings to the ASM service. Once this initial process is completed, the managed settings on the device may now be represented in the ASM Cloud Service and may be viewed and edited on the device or on the web using the ASM Web Admin.

The ASM Web Admin may automatically generate the proper user interface/form for management of the managed settings on a per device and per version basis. This may be done based on the uploaded settings configuration schema.

In embodiments, the methods and systems disclosed herein may comprise the ability to create, edit and save settings templates. These are configuration files that can be used to specify the desired settings for one or more purposed-devices. These settings templates may be applied to one or more devices, at which time the settings are written out for each device, and may be synchronized to the devices. Settings templates may be created and modified independent of being ‘applied’ to a device. This may allow for the settings templates to be modified without affecting any specific device. Once a template is completed, it may be applied to a set of devices by tag, or individually. When it is ‘applied’ the settings may be written out and stored for each device and a synchronization process may be initiated.

In embodiments, when new settings are written out in the ASM Cloud Service for a device, the service may contact the device using APNS (for iOS based devices) or C2DM and or GCM (for Android based devices). When contacted, the applications may use the provided ASM Client Library to contact the ASM Cloud Service and fetch any new settings configurations for the application.

In embodiments, in the event that the settings are modified on the local device, the application may use the ASM Client Library to contact the ASM Cloud Service to centrally store the current settings and modifications.

In embodiments, the synchronization process may enable a ‘push’ methodology for settings, where settings can be applied to a device in the cloud, and ‘pushed’ on demand to a purposed-device. This process may be desirable for, but is not limited to, enabling administrators that need to manage large numbers of applications on devices to quickly and effectively manage their devices. Likewise, a benefit to the systems and methods disclosed herein may also be to quickly and effectively manage devices that are geographically remote from the administrator, among other benefits such as providing remote support for purposed-device users.

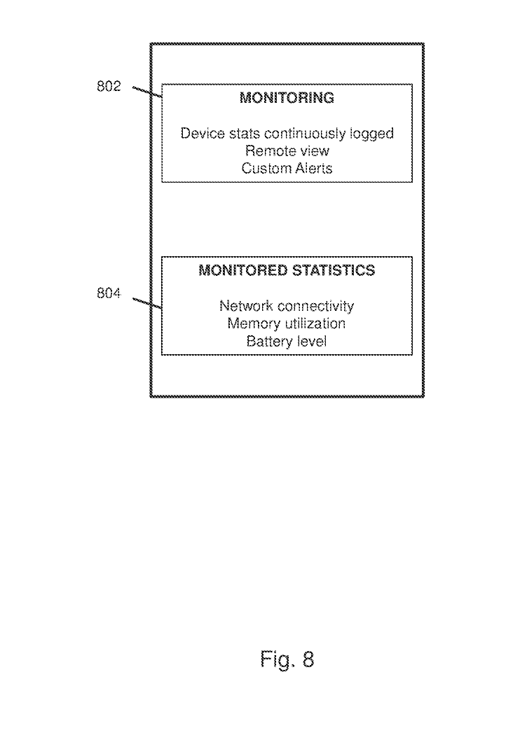

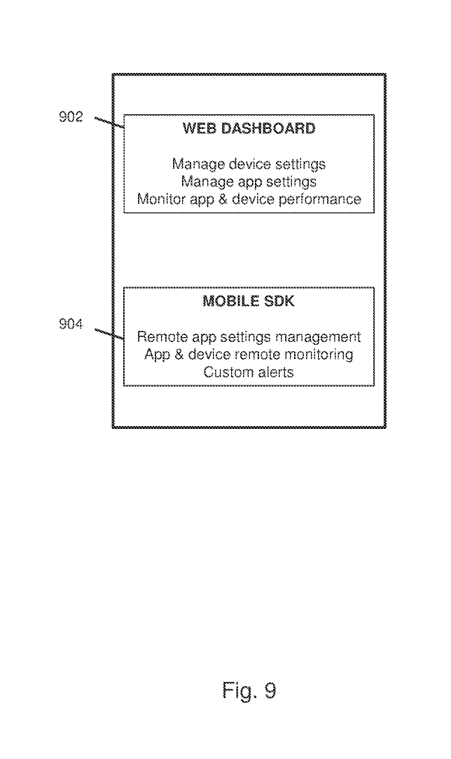

In embodiments, ASM functionality may be implemented on a “managed” device, meaning that the device is also enrolled and under management by an MDM profile. In other embodiments, the application may be run before the app is enrolled with MDM, or on a device that will never be enrolled with ASM. In embodiments, devices that are enrolled with ASM but not MDM may be monitored to retrieve information about the working environment that the device is in. The ASM library may be enabled to look for certain fields and device or app statuses and send them down to the platform system. In embodiments, the enhanced ASM library and/or Application Environment Monitoring module (AEM) may be enabled to monitor the app environment, rather than the settings and configuration. Referring to FIG. 8, in embodiments, the AEM of the PDMP, may monitor 802 and log app environment metrics and statistics 804, such as, but not limited to, CPU utilization, memory usage, network connectivity, network signal strength, and location. Logs and application performance data may be sent up to the PDMP on a schedule or on-demand. AEM Logs and data may then be processed by PDMP and may be available in a web dashboard 902, and enabled in part by the mobile SDK 904 associated with the PDMP, as shown in FIG. 9. This monitoring information may be utilized to troubleshoot many of the problems faced by single purpose deployments of purposed-devices, including, but not limited to, connectivity problems and crashes caused by memory leaks. With this information, developers and IT managers may have a more complete view of what is happening on a device and within an app to improve the user experience and app reliability. Capabilities include, but are not limited to, logs, screenshots, network monitoring, and system monitoring. Information collected may be available in the platform system's Web Console, which may include, but is not limited to, battery status, device name, IP address, WiFi network status, Bluetooth status, cellular network status, location coordinates, network status, processor load, process list, RAM used and available, storage space used and available, time awake since last boot (time device was asleep not counted), and MAC address.

The systems and methods disclosed herein may be implemented to operate within a variety of different operating systems, including, but not limited to, iOS and Android. In embodiments, iOS and Android implementations may be similar, using JSON to create a settings view file inside the mobile app. Settings values may then be tied to app logic, affecting the app experience. The settings view file may be used to render available settings within the app on the device and within the platform system dashboard. In embodiments, it may not be necessary to do any web development for the dashboard.

At app installation and enrollment, the view file may be sent to the PDMP and associated with the device and app so that it can be rendered within the PDMP dashboard. Individual settings may be marked as viewable within the web dashboard only, app only or both.

AEM implementation may involve simply including the SDK and setting the PDMP API key for the app. Logs and app performance data may then be scheduled to upload to the PDMP automatically or requested on-demand through the dashboard.

In embodiments, each device and app instance may enroll with the PDMP to enable remote management and monitoring. Enrollment may be done a number of ways, including, but not limited to, automatically to a defined account (e.g., an account of an enterprise or an account of an app developer) within the PDMP, or an end user may manually enroll an app with the end user's own unique identifier or enrollment code. In embodiments, a developer's app may identify itself to the PDMP using a unique app key. In embodiments, the PDMP may allow access to organizations, or tenants, who may use the PDMP to manage their devices. Each tenant may have multiple administrative user accounts. Each tenant may also have a unique ID. For example, without limitation, a tenant might be a retailer, and a store manager for each retail store of the tenant might have a unique ID for that manager's store, so that a purposed app for that store (e.g., to manage POS transactions) can be managed by that store manager (e.g., to monitor use of the app by that store's employees), while the app may be provided with consistent policies across the retailer's entire enterprise.

An app may be a solution consisting of a cloud component and a mobile component. The mobile part of the solution may present the user experience on a mobile device. The PDMP may be hosted in the cloud, with a user accessible web console for administration. Each purposed mobile app may have a unique key. In embodiments, there may be a one-to-one relationship between tenant and tenant ID, and between app and app key. However, the relationship between tenant and app may be one-to-many: a single tenant may have multiple apps, each with its own key. In embodiments the relationship between app key and tenant ID may be many-to-many. In addition to a tenant having multiple apps, a single app may have multiple tenants. For any tenant, an app may have multiple enrollment codes, which may help with convenience and flexibility.

In embodiments, for users and developers to obtain an app key or tenant ID, they may access the PDMP web console. The app key and tenant ID may be available in a number of designated areas in the web console, including, but not limited to, account settings. The app key and tenant ID displayed may then be copied to an app. Enrollment codes may be generated by the PDMP. Device management and app distribution features may require an MDM profile or app to be installed on the device, but ASM and AEM only features may not have this requirement.

In embodiments, an enrollment code may be used for multiple purposes. In a non-limiting example, the enrollment code may be used to register a device with the MDM. In another non-limiting example, the enrollment code may be used to register a user's purposed app with the PDMP.

In embodiments, a device may be managed by entering a valid enrollment code, which in turn downloads a set of management profiles onto the device. Users may see the profiles installed from a settings app installed on the device. Managed devices may be monitored and controlled from a central location using the PDMP.

In embodiments, an app may be registered by passing to an API that is associated with the PDMP either an enrollment code or tenant ID. In a non-limiting embodiment, app registration may not load any profiles onto a device, but rather it may let the SDK know about a purposed app running on a particular device. In embodiments, certain enrollment codes may be linked to specific settings categories, profiles or tags, so that it may be possible to use different codes for different device sets.

In embodiments, the Mobile Device Management module (MDM) of the PDMP may handle configuration and security for a fleet of devices. The MDM may be configured to operate with multiple operating systems, such as, but not limited to, iOS or Android devices. In a non-limiting example, on iOS devices, the MDM may be implemented via the installation of management profiles on the device. Once these are installed, many different elements of the device may be managed from a central location. Elements of the device that can be controlled through MDM include security features such as, but not limited to: a kill pill, requiring screen lock, an application lock, a lock on accessing data, or active screen lock. In embodiments, the MDM may comprise device configuration features such as, but not limited to, resetting the device, controlling apps installable on the device, controlling WiFi networks, controlling apps on the device, or provisioning/removing/allowing apps. The MDM may be designed to work together with purposed apps to create a complete suite of management options. In embodiments, the purposed app management may work with mobile device management tools that differ from the PDMP's MDM.

In embodiments, the systems and methods disclosed herein may be deployed as an Endpoint Security Service (ESS). The ESS may help businesses or other tenants assess the security profile and current security threat level for a particular device and app that has initiated transactions with an independent backend. The ESS may assess the integrity of a device by looking at multiple factors, including, but not limited to: geolocation, network connection, OS integrity (jailbroken, configuration, and the like), app integrity, app configuration and attached peripherals. In embodiments, the ESS may assign a security-level to a particular device based on the current state of the items listed above and other similar factors. Based on the security level, actions may be taken both on the device and at the transaction layer. In embodiments, devices may either have their app locked, have access to other apps locked, or the purposed-device may be entirely reset to factory settings. Transaction level actions may depend on the business rules put in place for transactions. In embodiments, the ESS may reside outside of regulatory requirements, such as PCI and CVV handling requirements, as transactions, in one embodiment, are not handled by the PCMP. Instead, transactions may be processed normally, but the originating device may be scrutinized using data relating to the security and integrity of the device. PCI and/or CVV requirements may include, but are not limited to, providing real-time security status, monitoring peripherals, protecting against malware, monitoring rooting or jailbreaking, monitoring events, securing logical access, securing coding practices, disabling app remotely, detecting loss or theft, securing support systems, disabling when offline, protecting against unknown apps, and evaluating and installing updates & patches.

In embodiments, the PDMP systems and methods disclosed herein may be used, for example by developers, to manage, configure, monitor and secure a purposed device, or plurality of purposed devices, that will enable a mobile POS system and/or application. In embodiments, the mobile POS system that is configured using the PDMP methods and systems, as described herein, may work in conjunction with the platform system MDM and platform system SDK to gather insight into the use of a device and determine its current security status. In embodiments, the mobile POS system may ensure PCI Compliance and auditability with a remotely monitored and managed solution that spans across the device, the app and the back end. In embodiments, the mobile POS system may feature application settings management. The mobile POS system may also comprise features such as app monitoring, for purposes such as, but not limited to, memory usage, CPU usage, or connectivity monitoring. The mobile POS system may comprise features such as mobile SDK, as well as a dashboard accessible by users via the Internet. In embodiments, the mobile POS may comprise features such as administrative alerts or security alerts, for purposes such as, but not limited to, low battery, disconnected internet connection, app heartbeat, security verification, change of location, rooting, or compliance. The mobile POS may comprise features such as, but not limited to, remote support, remote screen viewing, remote app configuration, or remote app update/install/removal.

In an embodiment, the present disclosure may disclose development of manageable purposed applications for iOS and Android using the PDMP. The PDMP may be modular, allowing developers of the apps to take advantage of the device management and app management components independently. In an embodiment, a purposed app may be configured to work with a combination of AEM module, ASM module, and MDM module.

In an embodiment of the disclosure, a method of registering with the PDMP may be disclosed. The method may include a user of the PDMP visiting a webpage to access the PDMP initiating the registration process by pressing a Get Started button presented on a display interface of the webpage. Pressing on the button may open a prompt that may include user intervention to populate a form presented to the user on the display interface of the webpage. The form may include fields such as name, company, email address, and phone number that may be populated by the user. The user may populate the fields displayed on the form, pressing a Create Account button on the display interface of the webpage, which may enable completion of the registration process.

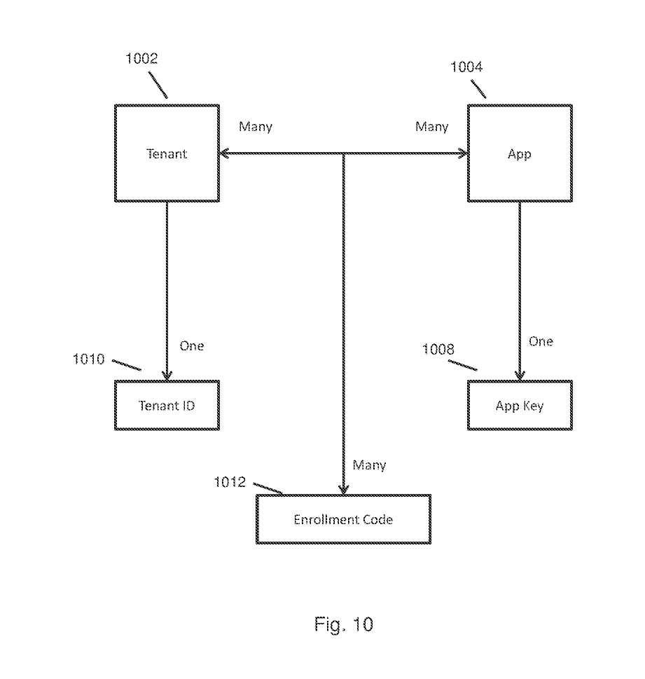

Once the user is registered with the PDMP, the user may use the platform to perform remote device and remote app management. In an embodiment, the user may be a developer and may use the PDMP to enable a user app that may hereinafter be referred to as a tenant app. Referring to FIG. 10, the tenant app may be enabled using at least three components of the PDMP including an app key, an enrollment code and a tenant ID 1010. A tenant component that may be associated with a tenant ID, an app that may be associated with an app key, and an enrollment code.

In an embodiment, the PDMP may include a tenant 1002 component that includes a user association with the tenant app 1004, such as an organization using the PDMP. Each tenant 1002 may have multiple user accounts for use with the PDMP. Each tenant 1002 may be associated with a unique ID (e.g., a tenant ID) 1010. In an embodiment, there may be a one-to-one relationship between tenant 1002 and tenant ID 1010; one tenant may 1002 be associated with a single tenant ID 1010. In embodiments, a user account may be associated with one or more tenants. In embodiments, a user account can be associated with 1 or more tenants.

The PDMP may further include an app that may be configured as a software solution to perform purposed functions for a user. In an example, the app may be a solution consisting of a cloud and mobile component. The mobile part of the solution may present the user experience, while the PDMP may be configured to operate the cloud, with a Web console for administration that may be accessible from the webpage associated with the PDMP. Each app may be associated with a unique key, such as an app key. The app and app key may have a one-to-one relationship, while the relationship between tenant and app may be one-to-many, that is to say, a single tenant may have multiple apps, each with its own key. Further, the relationship between app key and tenant ID may be many-to-many. In addition to a tenant having multiple apps, a single app may have a plurality of tenants.

The PDMP may further include an enrollment code component 1012. The enrollment code 1012 may be associated with a device or devices that may be used to access the PDMP. For any tenant, an app may have multiple enrollment codes. This may provide convenience and flexibility to the tenant, such as the user of the PDMP.

In an embodiment, the app key 1008 and the tenant ID 1010 may be obtained from a display interface such as a web-based console that is associated with the PDMP. The web-based console may include a portion for account settings that may include a drop-down menu for selecting the account settings. The web-based console may also include a developer tools tab. In an example, the developer tools tab may be associated with a briefcase icon. The app key 1008 and the tenant ID 1010 may be displayed by clicking on the developer tools tab and may be copied to the user app.

In an example, the user may need a different key for each app developed by the user using the PDMP. The key may follow the standard Java Universal Unique Identifier (UUID) format as illustrated below:

<8 alphanumeric characters>-<4 alpha>-<4 alpha>-<4 alpha>-<12 alpha>

For example, a key might look like a01b01cd-ef23-gh45-67ij-89k1lmno2345. The key may be used by the app to identify itself to an application programming interface (API) for use in developing the app.

In an example, the enrollment code may include a multiple character (e.g., 7-character) code that may be configured to register a specific app on a specific device to an app for a tenant. This may enable an app to use AEM and ASM. The enrollment code may also be referred to as a “short code.” To obtain an enrollment code, the user may navigate to the web-based console, as described herein. The web-based console may include a display interface for obtaining the enrollment code.

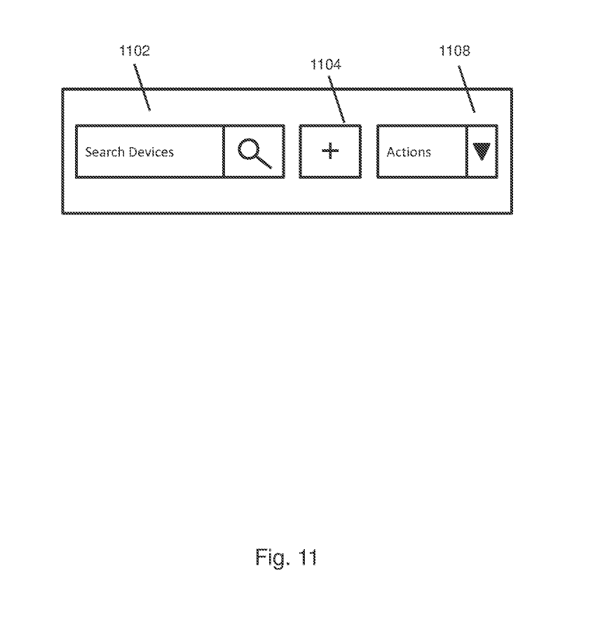

FIG. 11 illustrates an example of the display interface for obtaining the enrollment code. The display interface may include a portion displaying a search field 1102, a portion displaying a plus sign button 1104, and portion displaying an action button 1108. The search field 1102 may be associated with a search button that may be used to search for a device to enroll to the PDMP. Once a user searches for a device, and presses the plus sign button 1104, a display showing an alert message, such as a prompt display, may appear.

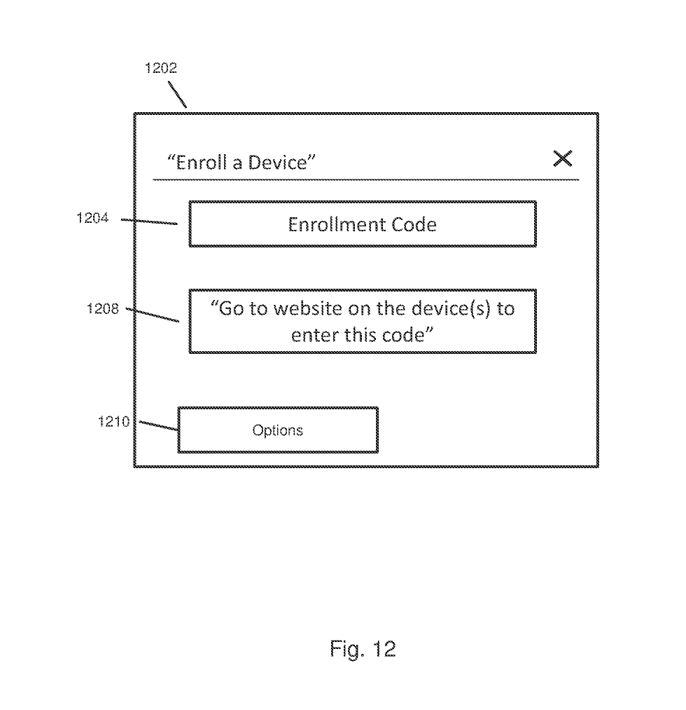

FIG. 12 illustrates an example of the prompt display. The prompt display 1202 may include a title section, such as for displaying a heading associated with the prompt display. FIG. 12 illustrates the heading as “Enroll a device”. The prompt display may further include a portion of the display just below the title section presenting the 7-digit enrollment code 1204 to the user. The enrollment code 1204 may be used for at least two different functions. First, it may be used to register a device with the MDM of the PDMP 1208. Second, it may be used to register the device's purposed app. In an example, to provide management of the device's app, the functionality of the MDM and AEM/ASM modules may be combined to achieve device and app management functionality of the PDMP and present to a user different device management options 1210. Alternatively an app may be registered with the MDM already on the device and apps may be registered with AEM/ASM components of the PDMP.

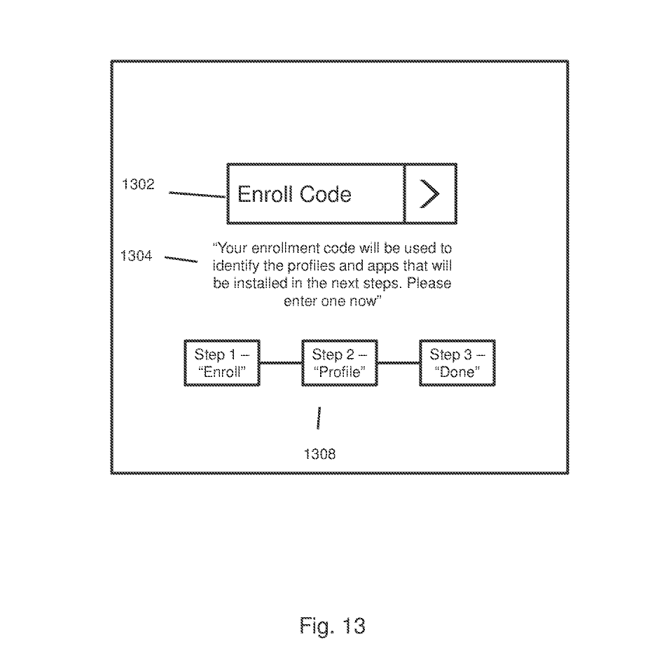

FIG. 13 illustrates an example of a display interface associated with a method for registering a device with MDM. The method may include navigating to the device's browser and entering a URL associated with the webpage of the PDMP. The URL may be associated with a webpage that may include the display interface. The display interface may include an enrollment code text field, a navigation button, and a process flow display graphic.

The user may enter an enrollment code in an enrollment code text field 1302 and click on the navigation button. Information 1304 describing for the user the uses of the enrollment for identifying profiles and applications for the subject device, and the steps in the enrollment process 1308. If the enrollment code entered by the user is valid, clicking on the navigation may cause the device associated with the enrollment code to download an MDM profile (iOS) and enroll with the PDMP for MDM (iOS and Android). For example, on a device having iOS, clicking on the navigation button may cause downloading of a set of management profiles onto the device. The profiles may then be viewed under the Settings section under the General/Profiles functionality of the iOS device. Once the device becomes managed, it may be possible to monitor and control the device from a central location.

In an embodiment, to register an app a developer may provide the API either an enrollment code or tenant ID in the application code. Unlike the device registration, the app registration may not load any profiles onto a user's device. It may simply inform a software development kit (SDK) associated with the PDMP about a purposed app running on a particular device.

In an embodiment, the enrollment codes may provide a flexible way of registering apps with the PDMP. The user may tie certain enrollment codes to tags in the PDMP so that it may be possible to use different codes for different device sets. The enrollment code may be used by enabling a feature that requires the purposed app to ask the user for the code before using the app. This may be done from an intro screen, requesting the code before the app performs other activities.

In an embodiment, a tenant ID may be defined as a unique ID for each tenant of the PDMP system. Each tenant may represent an organization, or entity. The tenant ID may have the same format as the app key, with a sequence of five alphanumeric character groups separated by dashes.

In some embodiments, the tenant ID may be used to enroll an app without prompting the user. This may be used for example in simple situations including a simple relationship, such as a single tenant with a single app and a limited use case. However, if an app works with multiple vendors, on large deployments, the enrollment code approach may be more suitable. The PDMP may also expose APIs to partners and enable them to automatically provision tenant accounts and enrollment codes from their own systems to give partners further flexibility in managing accounts and device and application enrollments.

In an embodiment, an exemplary purposed app, hereinafter referred to as GuestGuide may be disclosed, to illustrate the functionality of the PDMP.

The GuestGuide may be configured to provide “useful information to guests,” whether those guests are at hotels, events, or anywhere else where someone just showing up needs a few tips on what's going on, and where they need to be. The GuestGuide may be a simple app that rotates between a set of announcements for guests. It may get the announcements and background images for them from the PDMP settings, and then may display them, changing every few seconds to a new announcement.

The MDM may handle configuration and security for a fleet of devices. On iOS devices this may be accomplished by installing management profiles on the device. Once these are installed, many different elements of the device may be managed from a central location. Elements of the device that may be controlled through MDM may include security features including but not limited to, a kill pill, a require screen lock or active screen lock, a plurality of device configuration elements such as resetting the device, controlling apps installable on the device, controlling Wifi networks, controlling apps on the device, provisioning, removing, or allowing apps.

In an embodiment, the MDM may be designed to work together with purposed apps to create a complete suite of management options. However, it may be modular, so that purposed app management may work with MDM from other vendors.

Purposed-device solutions may have a set of special challenges. It may be annoying for the user when a consumer app freezes up. In such a scenario, generally the user notices app failure, and usually closes the app and restarts it. In a purposed solution, apps sometimes freeze up as well, making the solution useless to the next person who comes up to the device to use it. There needs to be a way to make sure your app has network access, its device has enough battery power, and that the app is running properly.

In an embodiment, the AEM module of the PDMP may provide remote monitoring to keep track of what is going on with a purposed app. The capabilities of the AEM module may include, but are not limited to, log generation, capturing screenshots, hardware monitoring, and system monitoring. The information collected by the AEM module while monitoring may be made available in the web based console of the PDMP. The monitoring information may be used to troubleshoot and keep an app up and running. The app may push logs and screenshots to the PDMP, and may also request them at any time. A full list of AEM attributes visible from the web-based console may include such as battery status, device name, IP address, Bluetooth of other short-range network status, WiFi status, cellular network status, location coordinates, network status, processor load, process list, RAM used and available, storage space used and available, time awake since last boot (time device was asleep not counted), MAC address or any other such attribute. Having this information available from a centralized console may make it easier to make sure an app is running properly, and may help to troubleshoot a range of hardware, connectivity, and app problems.

In an embodiment, the ASM module may provide options for how an application should function. For example, by default, the iOS Safari app uses Google to perform Web searches. Users may configure Safari to use Bing or Yahoo! instead. On iOS, the Foundation framework provides a mechanism for apps to get and set preferences with the NSUserDefaults class. Within this framework, apps may either display the user settings themselves, or make them available in the Settings app by using a Settings bundle. The iOS Settings app approach may be great for providing a consistent way of managing settings for a single user, but doesn't meet the needs of a purposed app. With purposed-devices, there needs to be a way to apply settings to fleets of tablet computers at once, rather than making changes onsite one at a time. Additionally, if an app is deleted or needs to be re-installed or remotely trouble shot, a system admin can view the current settings and apply changes if needed.

A purposed app may generally benefit from: a consistent way of handling settings and values; a centralized settings management, that is to say, a way to go to a Web page, define a number of settings, and then have those become active for an app across many devices; and an option for changing the app settings from the app itself. For example, a user may be on-site, and may like to make a quick change, or try something out. In this example, setting options from the device may provide a simple way to do this.

The ASM module of the PDMP may provide a consistent way for an administrator to control settings for apps across multiple devices from a single, centralized location. Centralizing settings management may make the app manageable in a purposed deployment. It may also provides an automated way for the app to present these settings options from the app itself.

In an embodiment, the app may be associated with a settings hierarchy.

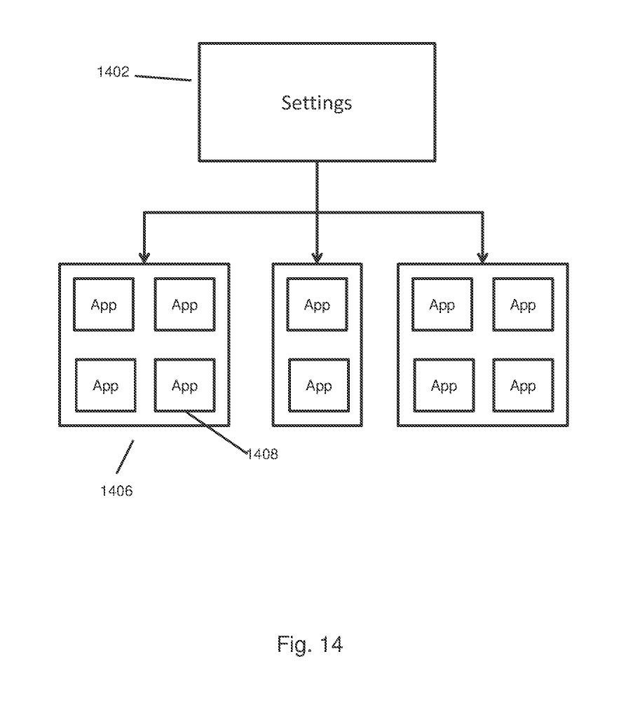

FIG. 14 illustrates an example of a block diagram for defining the app setting hierarchy. The block diagram indicates settings for a plurality of groups of apps 1406, such as a group of apps and a group of apps. The block diagram illustrates a settings 1402 hierarchy that may include defining what settings values of an app 1408 need to be exposed, and the relationships between them. The settings hierarchy may be expressed in a JavaScript Object Notation (JSON) file, which may be included with the app. An exemplary JSON file may be named as SettingsSchema.json.

The building blocks of the app settings hierarchy may include a core set of settings. In an embodiment, the core set of settings may include three components, a TextField, a ToggleSwitch, and a ComboBox.

The TextField may include a numeric or alphanumeric value, such as a password, user message, URL, ID, or number.

The ToggleSwitch may include one of two values, YES or NO. For example, allowing user touching.

The ComboBox may include a set of options, from which the user may select either a single option or multiple options.

These settings may be organized into a hierarchy using one or more of: Groups, Header, List, TabPane, and Pane.

A group may include a set of related configuration fields in a setting. Each app must have at least one group, but may have more than one. Each group may contain its own hierarchy of settings.

A header may functions as a separator, providing a way of setting off related settings items within a group.

A list may include a list of values, such as a list of URLs, a list of images for a slideshow that the app may cycle through. In an example, a conFIG. list of URLs to a set of images may be used with a set of settings values for each item in the list. For example, a list may be used to different time duration for each item displayed.

A tab pane may include a collection of alternative settings groups. For example, a tenant app may have the option of showing a Web page, a video, or a playlist of images. For each of those items, the administrator may have a different set of settings to choose from.

A pane may provide a way of nesting settings choices with a subordinate group of values. Instead of showing all values within a group, a set of related values may be tied to a single setting value.

In an embodiment, an exemplary illustration may be provided for creating two separate groups of configuration settings for the exemplary application GuestGuide discussed earlier. The two groups may include one group for general app settings, and another one for managing the app's behavior: General and Announcements.

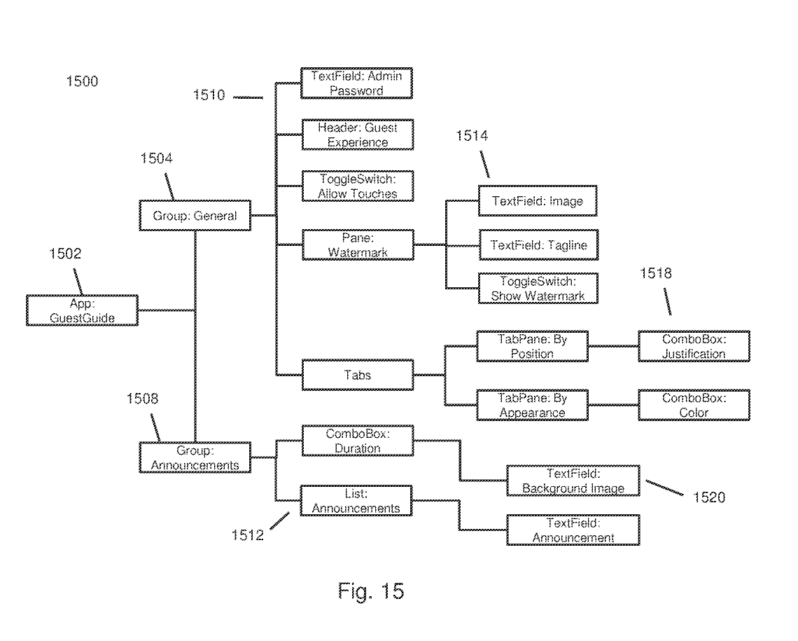

FIG. 15 illustrates an example of settings hierarchy for the GuestGuide application 1502, including two groups of settings, a group of general settings 1504 and a group of announcements settings 1508. The group of general settings may include a textfield setting 1510; 1514, a header setting, a toggle switch setting, a pane setting, and setting for tabs. The group of announcement settings may include a combobox setting and a list setting 1512.

The setting for TextField may include a setting for entering an Admin Password into the GuestGuide application. Additionally, the application may include some more controls in this group, which may be broken down or separated by defining the header setting that may be labelled “Guest Experience.” Additionally, the application may include an option to enable or disable user touching the toggleswitch setting titled “Allow Touches.” An option of adding a watermark to provide some branding for the hosting organization may also be provided by adding the pane setting. The Watermark Pane may further include three settings including, two text fields, Image and Tagline, and a ToggleSwitch titled “Show Watermark.”

The application may also include the tab setting, for adding some settings for controlling the display of a message. These settings may further include settings related to position, or alternately, by color, such as the settings tabpane by position, tabpane by appearance, combobox by justification 1518 and combobox by color.

Further, the application may include the announcement settings that may include settings for a list of guest announcements that application may cycle through, so the primary element of this group will the List setting defining the list of announcements and it may also include the combobox setting defining the duration for which the announcements may cycle. The list setting may further be associated with settings for textfield for background image 1520 and a setting for a textfield for announcement. Each announcement in the list may have a duration and some settings for the content and style.

An exemplary JSON file for defining the settings discussed above may be defined as a SettingsSchema.json file and may start as follows:

```
{
  “Version”: 1,
“Groups”: [
{
“Title”: “General”,
“Type”: “Group”,
“Settings”: [
]
},
  {
“Title”: “Announcements”,
“Type”: “Group”,
  “Settings”: [
  ]
}
]
}
```

The syntax checking and correction in the JSON file may be performed using jsonlint.com. The API provided by the PDMP may be configured to log errors for a user such as a developer's assistance.

In an embodiment, within each group a number of settings values, as well as their hierarchy may be defined. For example, within the settings for general group 604, a JSON object, such as the textfield 604a for an Admin Password may be defined as

{
“Type”: “TextField”,
“Title”: “Admin Password”,
“Value”: “”,
“Class” : “[Password]”,
“Key”: “adminPassword”
}

In this example, Type may describe the kind of object this is, and Title may define what the system administrator will see in the web-based console and local settings user interface (UI). Each setting may have a key that may be unique to the app, indicated by Key name in the value pair. This unique key may be referred to from an app such as the GuestGuide application. Value may define a default value for the setting. This field may also be left blank, but the line may still need to be part of the JSON object. In the example above, Class may be an optional attribute that may instruct the control to conform to a specified behavior. In this case, the control may behave as a password field, masking characters entered.

Most of JSON objects may need Type, Title, Value and Key to be defined, just as illustrated in the example above.

In a similar example, the JSON for the header setting may be defined as follows:

{
“Type”: “Header”,
“Title”: “Guest Experience”
}

Unlike other settings, headers may not need the Key or Value attributes because they only affect presentation.

Similarly, the toggleswitch setting may be defined as follows:

{
“Type”: “ToggleSwitch”,
“Title”: “Allow Touches”,
“Value”: “”,
“Key”: “allowTouches”
}

Another element of the GuestGuide user experience is a branding watermark. The Pane setting to break this out may be defined as:

Tagline, and a Toggle Switch titled “Show Watermark.”

{
“Type”: “Pane”,
“Title”: “Watermark”,
“Settings”: [
{
“Title”: “Image”,
“Type”: “TextField”,
“Value”: “”,
“Key”: “watermarkImage”
},
{
“Type”: “TextField”,
“Title”: “Tagline”,
“Value”: “”,
“Key”: “watermarkTagline”
},
{
“Type”: “ToggleSwitch”,
“Title”: “Show Watermark”,
“Value”: “0”,
“Key”: “showWatermark”
}
]
}

In an embodiment, a TabPane may be added to affect how the announcements display. The TabPane may be defined by two settings the TabPane by position, TabPane by appearance which may be defined as follows:

{
“Type”: “TabPane”,
“SelectedTab”: 0,
“Key”: “appearancePane”,
“Tabs”: [
{
“Title”: “By Position”,
“Settings”: [
{
“Title”: “Justification”,
“Type”: “ComboBox”,
“Class” : [“Single”],
“Value”: “0”,
“Key”: “position”,
“Options”: [
{
“Title”: “Left”,
“Value”: “1”
},
{
“Title”: “Right”,
“Value”: “2”
}
}
]
},
{
“Title”: “By Appearance”,
“Settings”: [
{
“Title”: “Color”,
“Type”: “ComboBox”,
“Class” : [“Single”],
“Value”: “0”,
“Key”: “color”,
“Options”: [
{
“Title”: “Red”,
“Value”: “1”
},
{
“Title”: “Green”,
“Value”: “2”
},
{
“Title”: “Blue”,
“Value”: “3”
},
{
“Title”: “Black”,
“Value”: “4”
}
]
}
]
}
]
}

In an embodiment, the settings may be defined for the second group, Announcements. This group may start with a duration setting that may apply to all announcements displayed:

{
“Type”: “ComboBox”,
“Title”: “Duration”,
“Class” : [“Single”],
“Value”: “1”,
“Options”: [
{
“Title”: “30Seconds”,
“Value”: “.5”
},
{
“Title”: “1Minute”,
“Value”: “1”
},
{
“Title”: “2Minutes”,
“Value”: “2”
},
{
“Title”: “3Minutes”,
“Value”: “3”
}
],
“Key”: “duration”
}

Further, the list may be defined as follows:

{
“Type”: “List”,
“Title”: “Announcements”,
“Key”: “announcements”,
“ItemTemplate”: [
]
}

Inside of ItemTemplate array the fields for the announcements may be defined as follows:

{
“Type”: “TextField”,
“Title”: “Announcement”,
“Value”: “”,
“Key”: “announcementText”
},
{
“Type”: “TextField”,
“Title”: “Background Image”,
“Value”: “”,
“Key”: “backgroundImageURL”
}

Further, inside of the settings for each of the tabs the corresponding items may be added. For Simple Text the Announcement and BackgroundImage TextFields, and for Web Page a Title and URL TextFields may be added.

In an embodiment, while making changes to the SettingsSchema.json file, the version may also be updated so that the API set may be able to know that a change may have been made. The Version attribute may just an integer and may be incremented by 1. In an example, the changed JSON file along with the new Version may be stated as 2 as follows:

### “Version”: 2,

This change may notify the PDMP to make a schema change. If a schema change is made, and version number is not incremented, the changes made previously may be ignored.

In an embodiment, the present disclosure discloses a method for building an app for an iOS or Android device. The method may include setting up the PDMP, and may further include setting up APNs and/or a project. The method may further include setting up an app delegate and with the settings in the app.

In an embodiment, setting up the PDMP may further include registering a tenant in the system, and getting an app key for the app. Once both these may have been obtained, the method may further include getting enrollment codes. Setting up the PDMP may require thinking through a settings hierarchy for the app and building the SettingsSchema.json file as described herein. Once the file is built, it may be checked for syntax using the jsonlint.com to make sure that the file is clean. This may complete the set-up of the PDMP.

In an embodiment, setting up the APNs may further include using an Apple Push Notification for an iOS device. Using the Apple Push Notification service, the iOS device may be configured to enable the app from a provisioning portal. In an embodiment, the app may be set up by a team agent. Further, the app may require enabling of APNs to get settings from the API. Setting up the APNs may further include enabling APNs in the Apple developer provisioning portal. Setting up the APNs may further include enabling the PDMP to work with the APNs. Setting up the APNs may further include setting up the app to use APNs.

In an embodiment, APNs may be enabled in a software provisioning portal to facilitate a developer in the provisioning of the app. For example, the portal may be Apple developer's provisioning portal and may include a display interface. From the provisioning portal, a user of the portal such as an agent may select an App IDs menu item in the display interface. Further, the user may select the option for configuration of the app, such as may be displayed using a “Configure” label and then clicking on a checkbox for enabling the push configuration option. In an example, the option may include a label such as a label displaying “Enable for Apple Push Notification service.” The configure option may not be visible to non-agent team members. Enabling the APNs may further include configuring the “Development Push SSL Certificate.” When the app is done, a Production certificate may need to be built. The next step in enabling the APN may further include accessing the agent's Mac and running the Keychain Access app. Inside the Keychain, a Certificate Assistant may be run. Further, an option for selecting Request a Certificate from a Certificate Authority may be selected from a cascading menu of the display interface. Further, from the cascading menu, the user may be asked for an email address and common name (for example, John Smith). The user may then press a “Save to Disk” radio button and then press a “Continue” button to save the new certificate signing request to disk. The default name for the certificate may be such as, CertificateSigningRequest.certSigningRequest. Once the certificate may be saved, the user may select an option to go back to the configuring app page from the provisioning portal. Further, after clicking on the configure link next to the app entry, the display interface may include line items, such as one for Development and one for Production certificates. Pressing the “Configure” button next to the “Development entry” may then cause a wizard to appear, titled “Generate a Certificate Signing Request” along with some instructions on using “Keychain Access”. The user may then press the “Continue” button. The next form that may then appear on the display interface maybe “Submit Certificate Signing Request.” The next step may then include pressing a “Choose File” button on the display interface and then uploading the Certificate Signing Request (CSR) that was made previously with Keychain Access. Subsequently, pressing the “Generate” button may send a notification to the user that the APNs SSL Certificate is ready and further pressing the “Continue” button may then download the certificate.

In an embodiment, the PDMP may be enabled to work with the APNs. The certificate that may have been downloaded as described herein, may need to be modified to use the certificate with the PDMP service. In an embodiment, the team agent may do this work on the same machine where the original CSR was created. The process may be started by having the agent go to the provisioning portal and download APNs certificate. For development, this certificate may be the

aps_developer_identity.cer.

The certificate may be imported into Keychain. Further, from the login keychain, filter may be applied to see only certificates. Further, an expandable option may be displayed on the display interface. The expandable option may be titled the “Apple Development Push Services”. The user may select to right-click on it, further click on an export menu option and then save it as apns-dev-cert.p12. Further, the file may be converted to the .p12 file to a .pem.

The method may further include running the terminal app to get to the command line. Further, the openssl command may be run. The format of the openssl command may be:

openssl pkcs12 -in apns-dev-cert.p12 -out apns-dev-cert.pem -nodes -clcerts

To enter the name of the .p12, the .p12 file may be selected from a finder function and then it may be dropped it into the user's terminal session.

This may bring in the apns-dev-cert.p12 file with the appropriate prefix path. The .pem file may now be used with the PDMP.

In an embodiment, a method for getting the certificate to the PDMP may include setting up a project in the platform. For example, a user may create an Xcode project. Setting up the project may further include getting the library and adding it to the project and further downloading a set of files, for example in the form of a zipped folder of files, included into the SDK of the PDMP, such as downloading the SDKMokiManageSDK.zip. The file may be downloaded from the web based console of the PDMP. The downloaded file may be viewed from the profile of the user on the PDMP by clicking on the developer tab. Clicking the developer tab may then display a link to the file. After unzipping the file, it may be possible to unzip the entire folder in the project. Unzipping the folder may create a group of files, such as the MokiManageSDK, which may include a plurality of files. The plurality of files may include an ASMControlValues.h file, a Detail ViewController.h file, an EnrollmentViewController.h file, a libMokiManageSDK. a file, a MasterViewController.h file, a MokiManage.h file, a SelectionListViewController.h file, and a SettingsStoryboard. storyboard file.

The unzipped folder may also include a folder called Buttons with 8 buttons needed for enrolling and un-enrolling.

In an embodiment, after unzipping the folder, the folder may be dragged into the SDK folder, such as the folder MokiManageSDK, into the project. This may further cause creating a group for the folder and placing the items there. First the group, such as the MokiManageSDK may be created and then the SettingsSchema.json file may be dragged into the project.

In an embodiment, the PDMP may use the APNs to push settings to the app and also the SDK, such as the MokiManageSDK binary library may be built for the device. In this embodiment, the app may be tested directly on the device. Further, a development profile may be used to test the app.

In an embodiment, the project may already include a UIKIt, Foundation, and a CoreGraphics frameworks. The project may require other frameworks as well, including but not limited to a CoreLocation framework, a CoreTelephony framework and a SystemConfiguration framework. Once the frameworks may be included, a boolean entry may be added to the info.plist file. For example a boolean entry displaying “Application uses Wi-Fi” may be added to the info.plist file and its value may be set to YES. Thplist may be associated with the target file.

In an embodiment, the apps may be set up to use the APNs. In order to set the apps, the app target's info.plist file may be updated with an entry to tell it which certificate to use. This may be accomplished by using the project to go to the app entry in the navigation pane. Further, a target may be selected from a TARGETS section in the portal associated with the PDMP and the Info tab may be chosen. Further, an entry called certType, of type Dictionary may be added. Setting up the app for using the APN may further include creating three subordinate entries in the certType dictionary labeled store, enterprise, and sandbox, with the names being in lower case.

As described herein, the certType dictionary may include three entries labeled store, enterprise, and sandbox and each of these may be made a Boolean type. The type being used may be set to NO or YES. To get started, sandbox may be set to YES. Additionally, the app delegate may be updated to respond to some APNs methods.

In an embodiment, setting up the AppDelegate may include starting in the AppDelegate.h file by including a file such as MokiManage.h such as illustrated below:

#import “MokiManage.h”

In the class declaration, the MokiManage protocol may be added to the delegate as illustrated below:

@interface AppDelegate : UIResponder <UIApplicationDelegate,
MokiManageDelegate>

Further, from the AppDelegate.m file, first a #define may be created for the api key as follows:

#define API_KEY @“whatever-your-apik-eyis-useitherenow”

Then, a session may be initiated the session with the MokiManage SDK from your app delegate's didFinishLaunchingWithOptions: method, calling the initializeWithApiKey method which may be illustrated as below:

NSError *error;
[[MokiManage sharedManager] initializeWithApiKey:API_KEY
launchingOptions:launchOptions
enableASM:YES
enableAEM:YES
asmSettingsFileName:nil
error:&error];

The method may then be assigned to the app delegate as illustrated below:

[[MokiManage sharedManager] setDelegate:self];

The object representing the PDMP may be implemented as a singleton, so that it may always be possible to use the class method sharedManager to get a pointer to the singleton. This means that it may not be required to define ivars or properties to access the PDMP, and the properties may be called from any of the objects.

In an embodiment, the MokiManageDelegate protocol may include at least five methods including a finishedRegistrationWithError method, a finishedUnRegistrationWithError method, a finishedRegisteringToANewTenantWithError method, a finishedPullingSettings method, a finishedPushingSettings method.

Each of these methods may be added to the AppDelegate.m file.

In an embodiment, the disclosure may include enabling APNs in the AppDelegate. Enabling APNs may include adding at least the following three application methods to the AppDelegate:

- (void)application:(UIApplication*)application
didRegisterForRemoteNotificationsWithDeviceToken:(NSData*)device
Token
- (void)application:(UIApplication*)application
didFailToRegisterForRemoteNotificationsWithError:(NSError*)error
- (void)application:(UIApplication *)application
didReceiveRemoteNotification:(NSDictionary *)userInfo

From the didRegisterForRemoteNotificationsWithDeviceToken method, the didReceiveRemoteNotification method may be invoked on the PDMP, such as the MokiManage object. A simple implementation of the method may be as follows:

```
  - (void)application:(UIApplication*)application
  didRegisterForRemoteNotificationsWithDeviceToken:
  (NSData*)deviceToken
{
  [[MokiManage sharedManager] setApnsToken:deviceToken];
  }
```

A silent register from this method may also be done, if that is the approach being taken with the app. In this case, the following line may be added to the previous method:

[[MokiManage sharedManager] silentlyRegisterDevice:TENANT_ID];

Further, appropriate error handling actions from the didFailToRegister . . . method may be added. Additionally, from the didReceiveRemoteNotification method, the information may be passed on to the MokiManage SDK as follows:

```
  -  (void)application:(UIApplication  *)application
didReceiveRemoteNotification:
  (NSDictionary *)userInfo {
  [[MokiManage sharedManager]
  didReceiveRemoteNotification:userInfo];
  }
```

In an embodiment, the PDMP may include methods and systems for enrolling a device with the PDMP. The device may be associated with a purposed app or app desired by the user. The app's device may have two forms of enrollment: MDM and AEM/ASM. MDM enrollment may add management profiles to the device, allowing monitoring and control of security and configuration. AEM/ASM enrollment may be independent of MDM, may be done programmatically, and may not add profiles to the device.

There may be at least two ways to enroll an app for a device: with a tenant ID, or with an enrollment code. As described herein, the tenant ID approach may be simpler, while the enrollment code may provide greater flexibility. In either case, the device may be assigned to a tenant in the PDMP system, such as the MokiManage system. Tenant ID enrollment may be done with no user intervention. However, this approach may only work when the purposed app has a single tenant. Enrollment codes may allow the purposed app to work with multiple tenants, and also provide additional flexibility by tying different enrollment codes to keys in the system, allowing the user to enroll the app for different use cases. If an enrollment code is used, the app may need to explain to the user how to get the code, and also ask for the code. The user may optionally be asked for a device nickname instead of the name assigned in Settings.

It may also be possible to un-enroll a device, so that the user may either retire it or assign it to another tenant or use case.

The methods for enrolling and un-enrolling a device may include the following:

— registerDevice:
— registerDevice: withNickname:
— silentlyRegisterDevice:
— unregisterDevice
— registerDeviceToANewTenant:

These methods may initiate the desired action. To determine when the action is complete, the app may use the MokiManageDelegate methods as illustrated:

— finishedRegistrationWithError
— finishedUnRegistrationWithError
— finishedRegisteringToANewTenantWithError

By using these object and delegate methods together, it may be possible to control setting, changing, or undoing registration.

In an embodiment, the disclosure includes methods and systems for working with settings. When a settings schema works, and the app delegate is working with PDMP working with settings may be initiated. Any view controllers that need to access the PDMP object may do so by accessing the object in the app delegate.

The following object methods may allow the app to initiate getting and changing settings:

— settings
— pullSettings
— saveSettings:

The following MokiManageDelegate methods may be configured to notify a user when the action has completed:

— finishedPullingSettings:
— finishedPushingSettings:

By combing the object and delegate methods, the settings for the app may be retrieved from the MokiManage object with the method:

-(NSDictionary*)settings;

This method may simply return the entire settings dictionary from the MokiManage object. To get settings from the server, a pull with the pullSettings method may be initiated, and then the delegate methods may be monitored.

Assuming the MokiManage object has already pulled settings, settings may return a dictionary representing the settings. A pointer to may be assigned to these settings, as follows:

self settingsD=[[MokiManage sharedManager]settings];

This dictionary has two keys. The Version key returns the version of the schema. It may be used to see if the PDMP is using the latest changes in the SettingsSchema.json file. The Values key may return the set of values, so getting to the settings may be illustrated as below:

NSDictionary*valsD=[self.settingsD valueForKey:@“Values”];

The key-value pairs in this dictionary may match the keys in the schema. For example, the dictionary tied to the GuestGuide SettingsSchemajson file may have the keys: adminPassword, allowTouches, announcements, appearancePane, duration, showWatermark, and watermarkImage.

The key may be used to define the SettingsSchema file to access individual settings. Arrays in the JSON settings file may be represented as arrays in Objective C as well, so getting the list of announcements for GuestGuide may be done with the following line of code:

NSArray*announcmentsA=[valsD valueForKey:@“announcements”];

This is an array of dictionaries, with each dictionary representing the settings declared in the list's ItemTemplate array. The key for each entry may be the same as the key for each setting declared, so for GuestGuide's list each dictionary may have an announcementText key and a backgroundImageURL key. These settings may then be used depending on the app's functionality.

In an embodiment, the previous steps may be skipped and any value may be retrieved with these _type_ForKey methods:

arrayForKey
boolForKey
dataForKey
doubleForKey
dictionaryForKey
floatForKey
integerForKey
objectForKey
stringForKey
URLForKey

In an embodiment, the disclosure may disclose handling of settings updates. The delegate method may be defined as follows:

```
  - (void)finishedPullingSettings:(NSDictionary *)
  settings WithError:(NSError
*)error;
```

The delegate method may notify a user that the settings have been updated. To notify any view controllers of the settings update, a notification may be posted when this method is called. The view controllers may then add themselves as observers, and have the related methods call the settings method to retrieve the new settings.

In an embodiment, the disclosure may include presenting the settings UI. The user app may present a view hierarchy to allow the operator to change the app's settings. The library may automatically generate this interface at the app's request.

The option of displaying the app's settings may be presented using a plurality of options including but not limited to, a secret gesture, like tapping seven fingers on the screen concurrently, or presenting a settings control somewhere in the app.

To bring up the settings controller and view hierarchy, from the view controller, the method displaySettingsView may facilitate in providing the app delegate as a parameter as illustrated below:

[[MokiManage sharedManager] displaySettingsView:[[UIApplication
sharedApplication]delegate]];

When the operator, such as a user of the app, is done using the settings, control may return to the location where the method was invoked.

In an embodiment, the methods and systems of the disclosure include an SDK for the PDMP that may allow a user, such as a developer of apps, to enable their tablet computer app for purposed use cases, enabling app monitoring and centralized settings management. The methods and systems disclosed herein may also enable the app to work in conjunction with the PDMP's Mobile Device Management (MDM) module, or with some other system already deployed on the user's device.

In an embodiment, a sample SettingsSchemajson file may be defined as follows:

```
  {
  “Version”: 5,
“Groups”: [
{
“Title”: “General”,
“Type”: “Group”,
“Settings”: [
{
“Type”: “TextField”,
“Title”: “Admin Password”,
“Value”: “house”,
“Key”: “adminPassword”
},
{
“Type”: “ToggleSwitch”,
“Title”: “Allow Touches”,
“Value”: “”,
“Key”: “allowTouches”
},
{
“Type”: “Pane”,
“Title”: “Watermark”,
“Value”: “”,
“Settings”: [
{
“Title”: “Image”,
“Type”: “TextField”,
“Value”: “”,
“Key”: “watermarkImage”
},
{
“Type”: “TextField”,
“Title”: “Tagline”,
“Value”: “”,
“Key”: “watermarkTagline”
},
{
“Type”: “ToggleSwitch”,
“Title”: “Show Watermark”,
“Value”: “0”,
“Key”: “showWatermark”
}
]
},
{
“Type”: “TabPane”,
“SelectedTab”: 0,
“Key”: “appearancePane”,
“Tabs”: [
{
“Title”: “By Position”,
“Settings”: [
{
“Title”: “Justification”,
“Type”: “ComboBox”,
“Class”: [
“Single”
],
“Value”: “0”,
“Key”: “position”,
“Options”: [
{
“Title”: “Left”,
“Value”: “1”
},
{
“Title”: “Right”,
“Value”: “2”
}
]
}
]
},
{
“Title”: “By Appearance”,
“Settings”: [
{
“Title”: “Color”,
“Type”: “ComboBox”,
“Class”: [
“Single”
],
“Value”: “0”,
“Key”: “color”,
“Options”: [
{
“Title”: “Red”,
“Value”: “1”
},
{
“Title”: “Green”,
“Value”: “2”
},
{
“Title”: “Blue”,
“Value”: “3”
},
{
“Title”: “Black”,
“Value”: “4”
}
]
}
]
}
]
}
]
},
{
“Title”: “Announcements”,
“Type”: “Group”,
“Settings”: [
{
“Type”: “ComboBox”,
“Title”: “Duration”,
“Class”: [
“Single”
],
“Value”: “1”,
“Key”: “duration”,
“Options”: [
{
“Title”: “30 Seconds”,
“Value”: “.5”
},
{
“Title”: “1 Minute”,
“Value”: “1”
},
{
“Title”: “2 Minutes”,
“Value”: “2”
},
{
“Title”: “3 Minutes”,
“Value”: “3”
}
]
},
{
“Type”: “List”,
“Title”: “Announcements”,
“Key”: “announcements”,
“ItemTemplate”: [
{
“Type”: “TextField”,
“Title”: “Announcement”,
“Value”: “”,
“Key”: “announcementText”
},
{
“Type”: “TextField”,
“Title”: “Background Image”,
“Class”: “Content”,
“Value”: “”,
“Key”: “backgroundImageURL”
}
]
}
]
}
]
}
```

### JSON Settings Schema Attributes

In an embodiment, the present disclosure may include a list of all of the tags that may be used in the SettingsSchemajson file. In JSON, objects may be described by a pair of curly braces:

{ }

Within these braces there maybe a collection of key-value pairs, enclosed in quotes. For each kind of settings object associated with the PDMP, there maybe a set of required key-value pairs, and for some objects, some optional pairs.

Collections of objects may be organized in arrays, bounded by square brackets:

[ ]

There may be three basic settings control objects, TextField, ToggleSwitch, and ComboBox. These may be organized by Group, List, TabPane, and Pane. Optionally, to improve presentation, the type Header may be used to separate controls.

A list of all the attributes used in these objects may include

Class

An optional attribute that may be used to assign special behavior to a setting control. Settings with special class behaviors are ComboBox, TextField, Pane, and ToggleSwitch. The classes HideInApp, HideInWeb, and HideInBoth may be used with TextField, ToggleSwitch, ComboBox, List, Pane, and TabPane.

The value for the Class key is an array.

ComboBox

A settings object type that may present a collection of values in a drop-down combo box control. By default, the combo box is a single-select control, but it can be defined for multiple selection as well as illustrated below.

{
“Title”: “My Title”,
“Type”: “ComboBox”,
“Value”: “0”,
“Key”: “myCombo”,
“Class” : [“Single”],
“Options”: [
{
“Title”: “One”,
“Value”: “1”
},
{
“Title”: “Two”,
“Value”: “2”
}
]
}

Class assignments may be Single, Multiple, HideInWeb, HIdeInApp, and HideInBoth. A single class assignment may cause the ComboBox to allow a single selection from its drop-down list, and a multiple class assignment may allow the user to choose multiple items. The others may provide options for hiding the control in the Web, App, or both interfaces.

In connection with the collection of settings groups for an app, the value that follows groups is an array. Any schema may have at least one group, but may have more. Each group is an element in an array of objects, as follows:

{
“Groups”: [
{
“Title”: “Group A”,
“Type”: “Group”,
“Settings”: [ ]
},
{
“Title”: “Group B”,
“Type”: “Group”,
“Settings”: [ ]
}
]
}
″:

The Title attribute is optional, but may be useful to improve readability.

A separator element that may insert a special title above a collection of settings controls. The header has no functional effect; its sole purpose is to improve the presentation of controls. The only additional element of a header is the Title.

{
! “Type”: “Header”,
! “Title”: “My Header”
}

Only Type and Title attributes may be required for this object.

ItemTemplate

This attribute may be required for the List object, and identifies the set of controls to be created for each item in the list. The elements inside the array may include the controls and groupings inside each element.

“ItemTemplate”: [ ]

The TabPane element may be used inside ItemTemplate at this time.

Key

Key may be a required attribute for most objects. A unique key for the setting.

This key may be used to retrieve a value from a collection of settings. All settings that will be retrieved may have a unique key. Group, Header, and Pane do not require a unique key; all other settings do.

List

A list of settings controls. All items inside the ItemTemplate array may be repeated for each element of the list.

{
“Type”: “List”,
“Title”: “Announcements”,
“Key”: “announcements”,
“ItemTemplate”: [ ]
}

Options

A required attribute for ComboBox. This is always an array of one or more objects.

“Options”: [ ]

Pane

An object to subordinate a set of controls, placing them together on a nested control page. This provides a convenient way of building a sophisticated settings hierarchy where appropriate controls may be grouped together.

{
“Type”: “Pane”,
“Title”: “My Pane”,
“Value”: “”,
“Settings”: [ ]
}

SelectedTab

Required attribute for TabPane. States what the default tab is.

Settings

An array of settings to be assigned to a group, pane, or tab. An array always follows:

### “Settings”: [ ]

TabPane

A collection of alternative settings. Only one tab from the collection applies at any given time, based on what tab the administrator has selected. The outline for a tab pane may be expressed as follows:

{
“Type”: “TabPane”,
“SelectedTab”: 0,
“Key”: “someTabPaneKey”,
“Tabs”: [
{
“Title”: “Tab A”,
“Settings”: [ ]
},
{
“Title”: “Tab B”,
“Settings”: [ ]
}
]
}

Tabs A required attribute for TabPane, expressed as an array.

### “Tabs”: [ ]

TextField

An editable text settings control. A simple text field is expressed as:

{
“Type”: “TextField”,
“Title”: “My Text Field”,
“Value”: “”,
“Key”: “myTextFieldKey”
}

Even if left blank, Value should be present.

TextField may optionally have a Class value to assign special behavior. Classes may include Password, Color, Content, Int, Float, HideInApp, HideInWeb, and HideInBoth. These all affect what content is allowed in the control. An optional ValidationRegex attribute allows you to define custom content constraints for the text field. Any content that doesn't match the regular expression may be rejected. ValidationErrorMsg allows you to define a message to be displayed when the content of the control is rejected.Tooltip lets you define text to be displayed on the Web interface of the MokiManage console when the user hovers a mouse over the edit field.

A text field with all of these attributes may be defined in JSON as follows:

{
“Type”: “TextField”,
“Title”: “My Text Field”,
“Value”: “”,
“Key”: “myTextFieldKey”,
“Class”: “[Password]”,
“ValidationRegex”: “\hat{ }[a-zA-Z0-9]+$”,
“ValidationErrorMsg”: “Alphanumeric characters only”,
“Tooltip”: “Alphanumeric values allowed”
}

A required attribute for all controls and most grouping objects, Title may define the name of the setting to be displayed in the MokiManage console and in the in-app settings view. TextField, ToggleSwitch, ComboBox, Group, Header, List, TabPane, and Pane must have a title.

Toggle Switch

An ON/OFF settings control.

{
“Type”: “ToggleSwitch”,
“Title”: “My Switch”,
“Value”: true,
“Key”: “myToggleSwitch”
}
Value can be true or false.

Type

A type may be an attribute to describe the type of object. Possible values for this key may include but may not be limited to ComboBox, Group, Header, List, Pane, TabPane, TextField, ToggleSwitch, Value or any other.

A required attribute for TextField, ToggleSwitch, and ComboBox may describe the default value to be assigned to the setting.

A stand-alone key pair may be used to identify the version of the SettingsSchema.json file. Every time the file is changed, this value may be incremented by 1. If the version is not changed changes to the file may be ignored.

In an embodiment, iOS methods and objects may be described along with the methods that may be associated with a protocol, such as the MokiManageDelegate protocol. The methods and objects may include the following.

MokiManage Class Reference

Inherits from NSObject

Declared in MokiManage.h

Related sample code GuestGuide

The methods may include methods for Connecting with the PDMP SDK including:

— apiKey
— didReceiveRemoteNotification:
+ initializeWithApiKey: launchOptions enableASM:
useStaging: asmSettingsFileName:
error:
— isReachable
— setApnsToken:
+ sharedManager

The methods may include methods for device registration including:

— isRegistered
— registerDevice:
— registerDevice: withNickname:
— registerDeviceToANewTenant:
— silentlyRegisterDevice:
— unregisterDevice

The methods may include methods for working with settings including:

```
- arrayForKey:
- boolForKey:
— dataForKey:
— dictionaryForKey:
- displaySettingsView:
— doubleForKey:
— floatForKey:
— settings
— integerForKey:
— objectForKey:
— pullSettings
— saveSettings:
— stringForKey:
  — URLForKey:
  — apiKey
  — - (NSString *)apiKey;
—
    apiKey
    arrayForKey
    - (NSArray *)arrayForKey:(NSString *)key;
    boolForKey
    - (BOOL)boolForKey:(NSString *)key;
    dataForKey
    - (NSData *)dataForKey:(NSString *)key;
    dictionaryForKey
    - (NSDictionary *)dictionaryForKey:(NSString *)key;
    didReceiveRemoteNotification
    - (void)didReceiveRemoteNotification:(NSDictionary *)userInfo;
    userInfo
    -(void)application:(UIApplication*)application
didReceiveRemoteNotification: (NSDictionary *)userInfo {
[self.mokiManage didReceiveRemoteNotification:userInfo];
}
```

displaySettingsView

Invoke a split-view controller and display the view hierarchy to review and edit settings from your app. Changes made in your app are uploaded to the system.

For most purposed app scenarios, the end-user may not have any reason to view or change the app settings. However, there may be cases where an operator is at the device and would like to make an immediate change, rather than using the PDMP Web console. This operator needs a way, not obvious to typical users, to access settings from the app. One good way to accomplish may be to provide a multi-finger touch option. When this interface is used, the app may invoke the settings controller and view hierarchy with a single line of code:

```
      [[MokiManage sharedManager] displaySettings
      View:[[UIApplication
sharedApplication]
delegate]];
      doubleForKey
      Returns the double value for the specified key.
- (double)doubleForKey:(NSString *)key;
```

Parameters

Key

The settings key for the desired value.

Return Value

The double value of the setting.

floatForKey

Returns the float value for the specified key.

-(float)floatForKey:(NSString*)key;

Parameters

Key

The settings key for the desired value.

Return Value

A float value for the specified setting.

Settings

Retrieve the app settings in the form of a dictionary.

-(NSDictionary*)settings;

Discussion

In an embodiment, the dictionary returned may have two keys, Values and Version. All settings are key pairs inside the values dictionary. Settings may be accesses by retrieving the key assigned in the SettingsSchemajson file. List values may be returned as arrays. All settings in a list associated with the itemTemplate attribute are dictionaries. This call only accesses the local MokiManage object; it does not call the server.

integerForKey

The integer value for the setting associated with the specified setting. -(int)integerForKey:(NSString*)key;

Parameters

Key

The key for the desired setting.

Return Value

An (int) value for the specified key.

isReachable

Checks to see if there is a connection.

-(BOOL)isReachable;

isRegistered

Determine if the app has registered successfully.

-(BOOL)isRegistered;

Return Value

Returns YES if the device is registered, NO if it isn't.

objectForKey

A pointer to the object associated with a the specified key. nil if there is no object.

-(id)objectForKey:(NSString*)key;

Parameters

Key

The key for the settings object.

Return Value

A pointer to an object associated with they key.

pullSettings

Pull most recent settings from the server.

-(void)pull Settings;

When settings are downloaded, the delegate method finishedPullingSettings:

withError: will be called.
registerDevice
Register this device with ASM/AEM using a
7-character enrollment code, issued from
the
MokiManage console.
- (void)registerDevice:(NS String *)shortCode;
- (void)registerDevice:(NS String *)shortCode
withNickname:(NSString *)nickname;
Parameters
shortCode

The 7-digit code issued from the MokiManage console.

Nickname

A name to use in the PDMP console instead of the device's configured name.

This method may be a flexible way to register a device. To do this, the app will need to expose a user prompt to ask for the enrollment code. For many apps, the simplest way to do this is to present a prompt screen that explains the need for enabling device, and how to get the enrollment code. A single textField prompt allows the user to supply the code. Once supplied, the app can call this method to enroll. If a nickname is used, the app should also prompt the user for a nickname to give to the device. This provides a quick way to assign a more readable or memorable name to the device, without having to change its name in Settings.

registerDeviceToANewTenant

Using a new enrollment code, reassign the app's device to a new tenant.

-(void)registerDeviceToANewTenant:(NSString*)shortCode;

Parameters

shortCode

The short code assigned from the new tenant.

saveSettings

Apply settings changes made inside the app.

-(void)saveSettings:(NSDictionary*)settings;

Parameters

Settings

The dictionary of settings to apply.

When settings have been applied, the delegate method finishedPushingSettings: withError: is called.

setApnsToken

Sets the device's APNs token.

-(void)setApnsToken:(NSData*)token;

The APNs token passed from the didRegisterForRemoteNotificationsWithDeviceToken: method.

A simple example of this method would be to call it from the app delegate method as follows:

```
    - (void)application:(UIApplication*)application
didRegisterForRemoteNotificationsWithDeviceToken:
(NSData*)deviceToken {
[self.mokiManage setApnsToken:deviceToken];
// register device using enrollment code or silent registration
}
    sharedInstanceWithApiKey
```

The following methods may be associated with the delegate protocol. The app delegate may conform to the protocol, dealing with each of these methods. The methods may deal with two aspects of working with the PDMP, such as the MokiManage platform registration: registration and handling settings.

finishedRegistrationWithError

This method is called when Device registration is completed. The operation is initiated by the app calling registerDevice: or registerDevice:withNickname:.

If there is an error, the error localized string will contain a description of the error; otherwise the object will be nil.

- (void)finishedRegistrationWithError:(NSError *)error;
finshedUnRegistrationWithError

Called when device un-registration has been completed. The process is initiated when the app calls unregisterDevice. If there was no error, the error object is nil.

If the operation failed, the error object contains the error and description.

- (void)finishedUnRegistrationWithError:(NSError *)error;
finishedRegisteringToANewTenantWithError

Called when a registration to a new tenant is completed. The process is initiated by calling registerDeviceToANewTenant.

If there is an error, the error object's localized string will contain the error description, and the code will contain the code.

- (void)finishedRegisteringToANewTenantWithError:(NSError *)error;
finishedPullingSettings

Called when the API has finished pulling settings from the server. A nil error return indicates a success.

```
  - (void)finishedPullingSettings:(NSDictionary *)settings
  WithError:(NSError
*)error;
  finishedPushingSettings
```

Called when the API has finished pushing settings to the server. A nil error object indicates success. Errors are indicated in the error object's code and localized description attributes.

```
  - (void)finishedPushingSettings:(NSDictionary *)settings
  WithError:(NSError
*)error;
  MokiManage SDK AEM Quickstart Guide for Android
```

In embodiments, systems and methods disclosed herein may comprise an app debugging support feature and remote mobile device support. The remote mobile device support method and system may detect a mobile device and at least one software application on the mobile device, within a network, wherein the detection occurs within a distributed computing environment that includes computing and storage facilities that are remote to the mobile device. Application operations information that is associated with the performance of the application may be monitored and an administrator enabled to remotely view the screen of the mobile device and record a session with a user of the mobile device. The application operations data, and the recorded session, may be logged, stored and uploaded to the distributed computing environment, and at least one of a pre-defined or developer-defined command be sent to the software application from the distributed computing environment based at least in part on the application operations data. Applications operations data may include, but is not limited to network calls made by the software application, operating statistics for the software application, performance statistics for the software application, data access calls made by the software application, queries made by the software application, or some other type of application operations data.

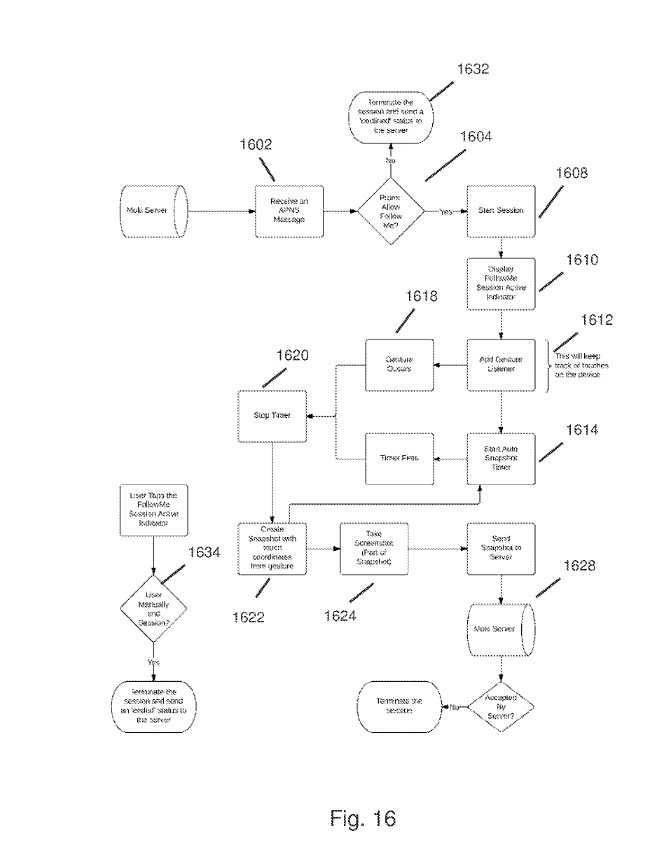

Referring to FIG. 16, the PDMP systems and methods disclosed herein may comprise an app debugging support feature. The support feature may be deployed to debug problems that a user experiences. In embodiments, the app debugging support feature may be operated in part by a platform support representative. The platform support representative may initiate a support walkthrough session on the device, sending a request 1602 to the device, which the device user may then accept or reject 1604. If accepted, the walkthrough session may be started 1608 and an indicator may be displayed 1610 indicating that the walkthrough session is active. In embodiments, a gesture listener may be added 1612 to keep track of touches on the device, along with an auto snapshot timer 1614. When a gesture occurs 1618, the snapshot timer may stop 1620, creating a snapshot with touch coordinates from the gesture 1622. A screenshot may be taken each time the user touches the screen 1624 and an image with touch coordinates and other metadata may be sent to the platform servers 1628. The auto snapshot timer may then be restarted to capture additional gestures 1630. The platform support representative may then follow along in near-real time with what the device user is doing by viewing the images via the PDMP web platform. In such embodiments, problems with apps may be addressed more effectively with the ability to follow a user's screen and a user's actions on a mobile device.

In embodiments, the app debugging support feature may comprise taking a screen shot of the user's screen every time the user taps the screen, or at a regular interval if the user isn't touching the screen, when the support walkthrough mode is enabled. Screen shots of the user's screen during the walkthrough session may then be uploaded to the PDMP server, along with touch coordinates and other metadata. The walkthrough sessions may also be saved automatically and reviewed at any time for quality control, training, or any other purpose.

In embodiments, APNS configuration may be required in order for the debugging support feature to work (e.g., in iOS devices). In embodiments, in order to initiate a debugging support walkthrough session, the support representative may login to the platform Web Dashboard. In the Web Dashboard, the support representative may select from a menu the app that requires support. The support representative may then select the device that the user is using. In embodiments, a menu accompanying the selected device may have a “Support” selection, which then may lead to other menu selections in order to initialize the walkthrough session. This same menu may also provide historical sessions that the support representative may view, under a “Previous Sessions” section, or the like.

In embodiments, the app debugging support feature may be implemented via Android. In embodiments, an app implementing the platform system SDK may receive an AEM action from Google Cloud Messaging requesting a debugging support walkthrough session. Such a message may also contain the session id. The walkthrough session requested may be broadcasted using the intent com.moki.followme. Additionally, the platform may set the current apps package name as a category on the intent as well as the sessionID as a string intent with the key sessionID. The app developer may then be required to register a broadcast receiver with an IntentFilter that has the same action and category. Inside the receiver, the developer may call MokiManage.openFollowMeDialog (Activity activity, Intent intent) passing in the current activity of the app and the intent passed into the receivers OnReceive function. The platform SDK may use this activity to get the current Window object and then use that window decor view to generate the screen shot. Additionally, the session id may be obtained from the provided intent. In embodiments, an Android dialog fragment may be used to provide a dialog to the end user who can accept the debugging support walkthrough session or decline it. If the session is declined, the session may be ended, reporting back to the server a “declined” status 1632. If the session is accepted, an Android Notification may be provided, which allows the user to end the session when they dismiss it, such as by tapping the session active indicator to manually end the session 1634. Once the user ends the session, the session will be terminated and an “ended” status may be sent to the server. The app developer may also have the ability to end the session at any time by calling MokiManage.endFollowMeSession( ). In either case, the platform may report back to the server requiring the session to be ended with a status “ended.”

In embodiments, once the session is accepted a timer may be started to send a snapshot to the server periodically. A snapshot may include but is not limited to the following information, a serialNum which is just a number starting at 1 which increments with every snapshot 1, 2, 3 etc., a timestamp containing the elapsed time in milliseconds since the epoch (1 Jan. 1970), an array of x y coordinates which contains the places touched on the screen during the current gesture, and the screenSize, comprising the dimensions of the image sent. Every snapshot may be accompanied by binary data of the image captured from the current screen. The snapshot may be sent as a multipart message with a json part and image part. In such a multipart message, a response code of the http request may be detected. If the code is code 403, the session may be ended assuming a timeout of the session or that the session was ended by the support user.

In embodiments, in order to generate the image, the platform SDK may use Android's View.getDrawingCache( ) function which returns a Bitmap Object. Other Android functions may be used as well, such as Bitmap.compress(android.graphics.Bitmap.CompressFormat format, int quality, java.io.OutputStream stream) on the bitmap with compression format Bitmap.CompressFormat.WEBP, at a quality of 6, and an instance of java.io.ByteArrayOutputStream. Additionally, ByteArray( ) may be read to the output stream and used as the binary for the report to SnapShot. Such compressions may save the app's memory and may speed up the http request.

In embodiments, a developer may track a user's gestures by implementing the FollowMeGestureDetector function passing in the MotionEvents from their app. Alternatively, a developer may gather all of the points for the gesture and utilize the MokiManage.reportFollowMeAction(Activity activity, Point . . . touches) function. In embodiments, any time a gesture is started, the running snapshot timer may be stopped and a snapshot may be queued to record the state of the app when the gesture starts. The timer may then be restarted so that images of the app as the gesture continues may be recorded, in the case of a long swipe. The same may be done when the gesture ends. A developer's calling of the MokiManage.reportNewFollowMeActivity(Activity activity) may be critical to the debugging support walkthrough functionality whenever the current activity of the app changes so that a current image of the app may be recorded.

In embodiments, the PDMP systems and methods disclosed herein may comprise a network performance diagnostic tool that is added into an app. Such a network performance diagnostic tool may be used to diagnose app performance issues that may be related to problems with network performance. In embodiments, the network performance diagnostic tool may run several checks to determine a mobile device's connectivity to a local network as well as the Internet and report back on the quality of the connection. Such a tool may be used to help support and development personnel understand if there is a connectivity issue, and if so, which component within the network stack is not working.

In embodiments, the network performance diagnostic tool may perform several actions every time the tool runs. Such actions may comprise, pinging the default gateway, pinging an outside host (such as google.com), pinging the PDMP platform, testing DNS connectivity and latency, validating that ports 53, 80, 443, 2195, 2196, and 5223 (on iOS) and ports 80, 443, 5228, 5229, and 5230 (on Android) are open, and issuing a GET request to the developer-defined URLs, and indicating whether the text specified is found in the response, among others.

In embodiments, the network performance diagnostic tool may run in various modes. One mode may run a single network performance diagnosis at every heartbeat. Another alternative mode may conduct duration testing and may include average latency, max latency, and missing packets, among others. Such a mode may not run on the heartbeat, but may require triggering to run. Such a mode may be ideal for support personnel during troubleshooting. The results of each network performance diagnosis may be uploaded the PDMP server. If the app is unable to contact the server, the results of the network performance diagnosis may be stored on the device until it is able to reach the server, when the stored diagnosis results may be uploaded.

In embodiments, URLs may be added to the network performance diagnosis tool. In iOS, MMNetworkReport.h class may be imported into the source file that is being coded. In the addURL method, the desired URLs and text strings of the network performance diagnosis may be added in full-qualified form. The following non-limiting examples show different URL and text string combinations. A developer may add as many combinations as needed or desired, for example:

```
    MMNetworkReport*  networkReport  =  [MMNetworkReport   new];
[networkReport   addURL:@“http://yahoo.com”  checkForString:@“Example  A”
error: error];
    [networkReport  addURL:@“http://mokimobility.com”
checkForString:@“Example B” error:error];
    [networkReport  addURL:@“http ://zdnet. com:107”  checkForString:nil
error: error];
[networkReport runBasicWithCompletionBlock:\hat{ }(BOOL succeeded){
        //get all report data in NSDictionary format
        NSDictionary* dictionaryReport = [networkReport encode];
            //get individual checks and data
    NSArray*  portList  =  [networkReport
networkChecksForCheckType:MMNetworkCheckTypePortScans];
        MMNetworkCheck* networkCheck = [portList objectAtIndex:0];
        NS String* result = networkCheck.result;
    }];
```

In Android, the Diagnostics.java class may be imported into the source file being coded. The desired URLS to be checked by the network performance diagnosis tool may then be added. The addHoststoCheck method may be used to add just URLS to the test. The addHostToCheck method may be used to add both URLS and text strings to the test. In embodiments, both methods may be used concurrently. The following non-limiting examples show several possible scenarios:

```
  addHostsToCheck(“http://yahoo.com”,  “http://mokimobility.com”,
“http://bing.com:107”);
  addHostToCheck(“http://google.com”, ”Example text string A”)
  addHostToCheck(“http://ibm.com:107”, ”Example text string B”)
```

In embodiments, the PDMP systems and methods disclosed herein may comprise custom action developer feature. The custom action developer feature may allow developers to define app-level actions that may be initiated remotely on the PDMP web platform. Such capabilities may potentially yield endless customization options as developers may create any desired action and run such an action from a network when needed. The custom action developer feature may be used to implement AB tests and data wiping, among other uses.

In embodiments, the custom action developer feature may be implemented via Android. In embodiments, the action may be received through Google Cloud messaging and then rebroadcast to the developer by calling android.content.Context.sendBroadcast (Intent intent) with the intent action com.moki.customaction and a string extra on the intent with the key customActionMessage and the value equal to the name of the action. The current apps package name may be set as a category on the intent so that other apps cannot receive the broadcast. The app developer may then register a broadcast receiver with an IntentFilter that has the same action and category where the developer can then write code for his or her app to function upon receiving such an action.

In embodiments, the PDMP may provide a set of predefined actions such as taking screenshots, getting logs, getting device location, sending messages, checking compliance, and the like. The custom action developer feature may allow developers to create their own action references that can be triggered on the device so that developers have the flexibility to add your unique action references that are specific to the needs of an app and its users. The custom actions may be included alongside the PDMP pre-defined actions on the PDMP dashboard. In embodiments, when a custom action is received, MMApplicationDidRecieveCustomActionNotification may be called. This notification conforms to Apple NSNotifications that are broadcasted through the NS Notification Center. The APNS notification received from the PDMP may be included in the userInfo of the notification. If an app has multiple custom actions defined, the action reference may be extracted from userInfo using [notification.userInfo objectForKey:@“command”]. In embodiments, messaging service may be required for custom actions to work (APNS, GCM, or the like).

In embodiments, a developed custom action may be added to the action list on the PDMP web dashboard. A developer may first log onto the PDMP website. Next, the developer may select a drop down option from the menu to change an App. When selected the custom action may be given a new name which will appear in the drop-down list for devices in the PDMP Web Dashboard. From here, the device may be instructed to access the custom action from the corresponding device drop-down menu, calling MMApplicationDidRecieveCustomActionNotification on the device.

In embodiments, a custom action may be scheduled. In order to schedule custom actions, a developer may first create an action group. When creating an action group, the developer may need to specify one or more tags. The tag or tags a developer uses for the action group may also be added to the devices the developer wants the action group to apply to. Tags may create the mapping between the action group and the devices. An action group may be created by selecting the corresponding drop-down menu item in the PDMP Web dashboard. The devices that the developer wants the actions to run on may need to be tagged with the same tag values in order to create an action group. Once the action group is created, the action group may be scheduled for times by selecting the corresponding option in the drop-down PDMP Web Dashboard menu. A schedule name, time and device time zone field may be populated as well as a desired action. Devices may be tagged with multiple tags.

In embodiments, the PDMP systems and methods disclosed herein may comprise endpoint security monitoring. In embodiments, such a security feature may monitor web requests made by an app. In embodiments, the whitelist may comprise a list of acceptable endpoints and may be uploaded to the PDMP server. In embodiments, endpoint security monitoring may periodically upload a list of endpoints the app has attempted to contact and compare the uploaded list to the whitelist. Developers may define a whitelist of endpoints and an alert may be triggered if the app attempts to call an endpoint not included in the whitelist. Such an alert may be sent directly to a developer's PDMP Web Dashboard. Such functionality may allow post-deployment security monitoring of the app and can help developers know if their apps have been compromised. In embodiments, endpoint security monitoring may be deployed automatically.

In embodiments, the Purposed-Device Management Platform (PDMP) of the present disclosure may include a Digital Interaction Tracking (DIT) component that may, in one embodiment, utilize the camera of a purposed device, as defined herein, to monitor, track and distribute data related to activities occurring in proximity to, and on, the purposed device. The DIT may include a Digital Interaction Tracking Dashboard (DITD) that may be used to present to a user a summary view of activities related to a device, a device impression summary, a device interaction summary, or some other data presentation and/or visualization of interactions that are occurring in the proximity of, or on, a purposed device or plurality of purposed devices.

In embodiments, the DIT may utilize the onboard camera of a purposed device and embedded device facial recognition APIs to determine that a person is in the proximity of the purposed device, is looking at the purposed device, and so forth. The facial recognition functionality may further enable detecting the identity of the person in proximity to the purposed device and/or determine if the person matches a person that has previously been in the proximity of, or interacted with the purposed device. In an embodiment, the detection of a person who has previously been in the proximity of, or interacted with a purposed device may be based on facial recognition that was obtained from a first purposed device at a Time 1 and a second facial recognition of the person using a second purposed device at a Time 2.

In embodiments, the DIT may utilize the onboard camera and embedded device facial recognition APIs of a purposed device to determine if a face that is recognized, as a human face and/or a particular individual's face, stays in focus for at least a minimum time duration (e.g., at least 2 seconds). The duration that the face is in focus may be used by the DIT to infer that the person is having a deeper engagement with the content on the screen of the purposed device, and the PDMP may initiate an action on the purposed device based at least in part on the presence of the inferred deeper engagement by the person. For example, the PDMP, may direct an application running on the purposed device to present a video, or present a coupon, or ask the person for their clothing size, or initiate some other action within an application. In another example, the PDMP may initiate an action on the purposed device, such as causing the device to make a sound to entice the person to have further engagement, increase the brightness of the display on the device, or some other action.

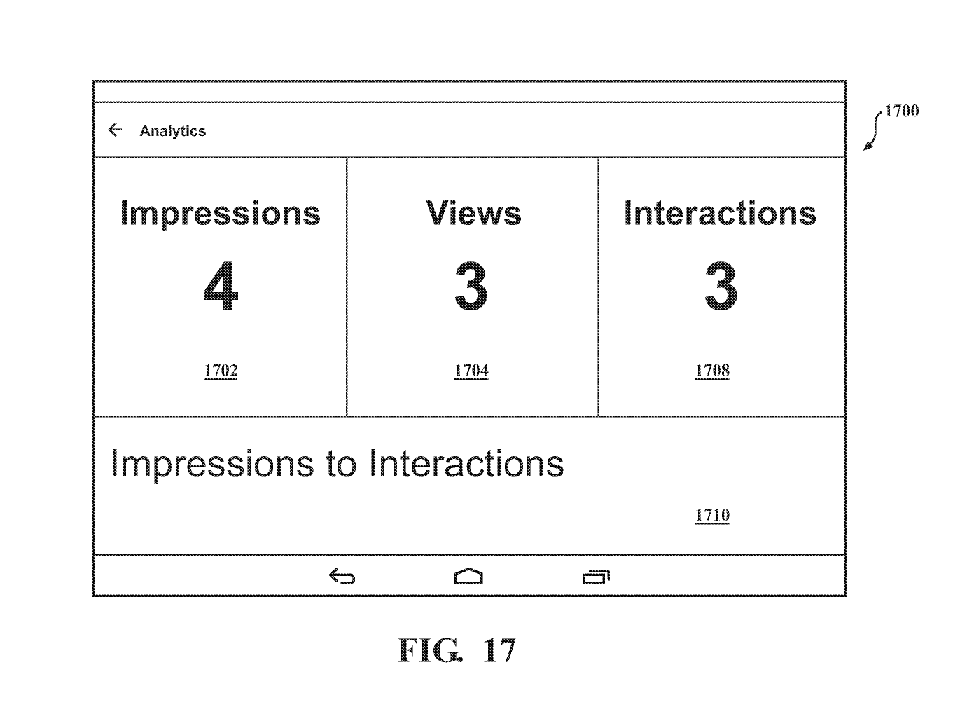

In embodiments, the DIT may record the combination of data derived from the camera of a purposed device and activities occurring on the device and within applications that are running on the device. This data may be visualized and presented in the DITD, as showed in FIGS. 17-19. FIG. 17 depicts a simplified embodiment of the Digital Interaction Tracking Dashboard, showing the relation among the impressions, views and interactions taking place on a purposed device. In FIG. 17, a simplified dashboard 1700 displays impressions 1702 of customers, e.g., a count of persons near the camera of a purposed, mobile device during a particular period of time, e.g., an hour, a shift, a day or other convenient time period. If the person or persons stay within view of the camera, as explained below, the impression may be converted to a view 1704. That is, the person may be sufficiently interested to view a display of merchandise that is monitored by the single purpose device. The person or persons may then remain in the vicinity and may interact with the display or device, e.g., touching or selecting merchandise or selecting an item from a menu on the purposed mobile device, e.g., a digital interaction 1708. The platform or the application may then correlate or tabulate the conversion of impressions to views, views to interaction, or impressions to interactions 1710.

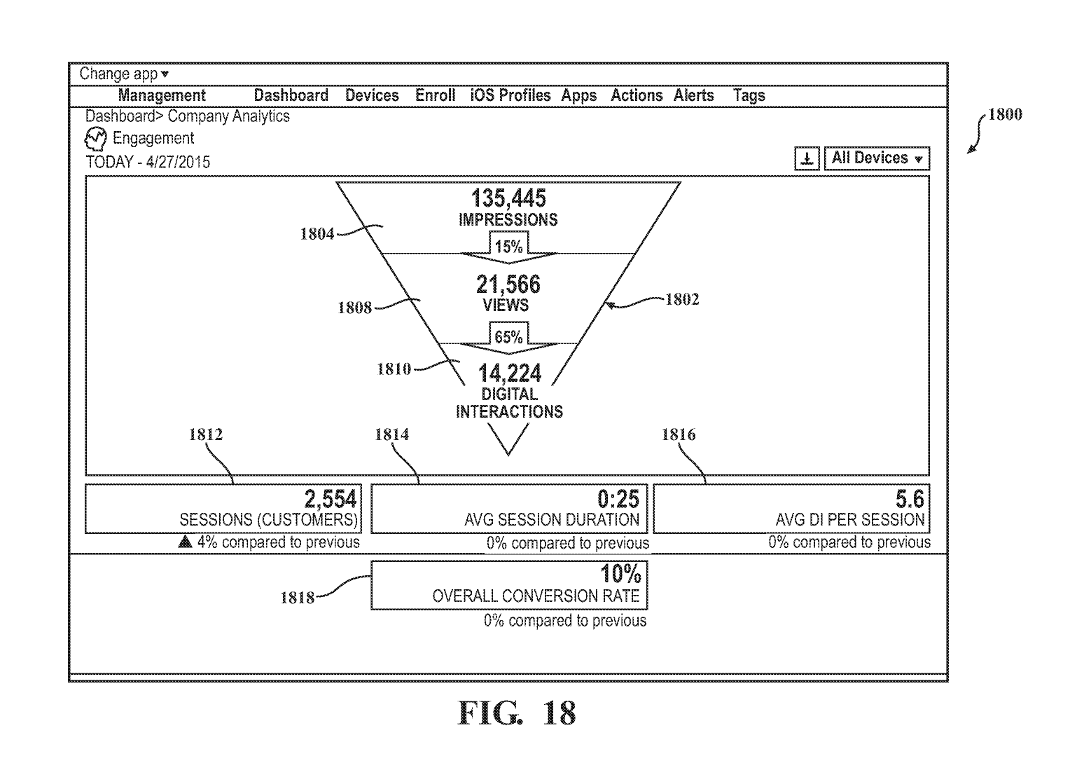

For example, a computer tablet, such as an iPad, may be deployed in a retail establishment as part of a fleet of purposed devices that are used to present photos and videos of clothes within an application(s) running on the purposed devices that enable a customer to interact with the application, such as changing the color or styling of the clothes that are presented within the application. Continuing the example, as the person approaches the iPad, the camera may be used to identify the object in the camera's field of vision as a human, or as a particular human. The matching may be performed by the PDMP using data obtained from a plurality of purposed devices, running a plurality of applications. Once a match is made (either to the object being a human or a particular human), the data may be time stamped so that the first presence of the human at the purposed device is recorded. A more sophisticated digital interaction tracking dashboard 1800 is depicted in FIG. 18. This embodiment displays aggregated impressions, views and interactions taking place on a purposed device or plurality of purposed devices, and their associated durations and conversion rates. In this dashboard, a graphical display 1802 charts the number of impressions 1804, the number of impressions that are converted to views 1808, and the number of views by persons who then proceed to a digital interaction 1810.

As seen in FIG. 18, the dashboard tracks and displays the conversion rate of impressions to views as 15%. The dashboard also tracks and displays the conversion rate of views to digital interactions, here 65%. The dashboard may also include other pertinent information, such as the number of sessions 1812 with customers, the average duration 1814 of a customer session and the average number of digital interactions per session 1816. Note that each of these also displays a comparison to a prior period, e.g., the previous day, week, month or other convenient period of time. FIG. 18 depicts the statistics for “all devices,” e.g., all devices in a store, in a region, or other grouping of mobile devices. The menu at the top of the dashboard allows users to view the dashboard that is seen here. Alternatively, the user may view reports on the devices, may enroll new devices, or use other functions of a system or network of single-purpose mobile devices. The functions may include iOS profiles, i.e., information summaries or profiles for other operating systems, or information or access to applications or apps on the purposed-device management platform. The user may also view specific actions taken by the system, alerts to the system or individual devices, profiles or tags for the individual devices, etc.

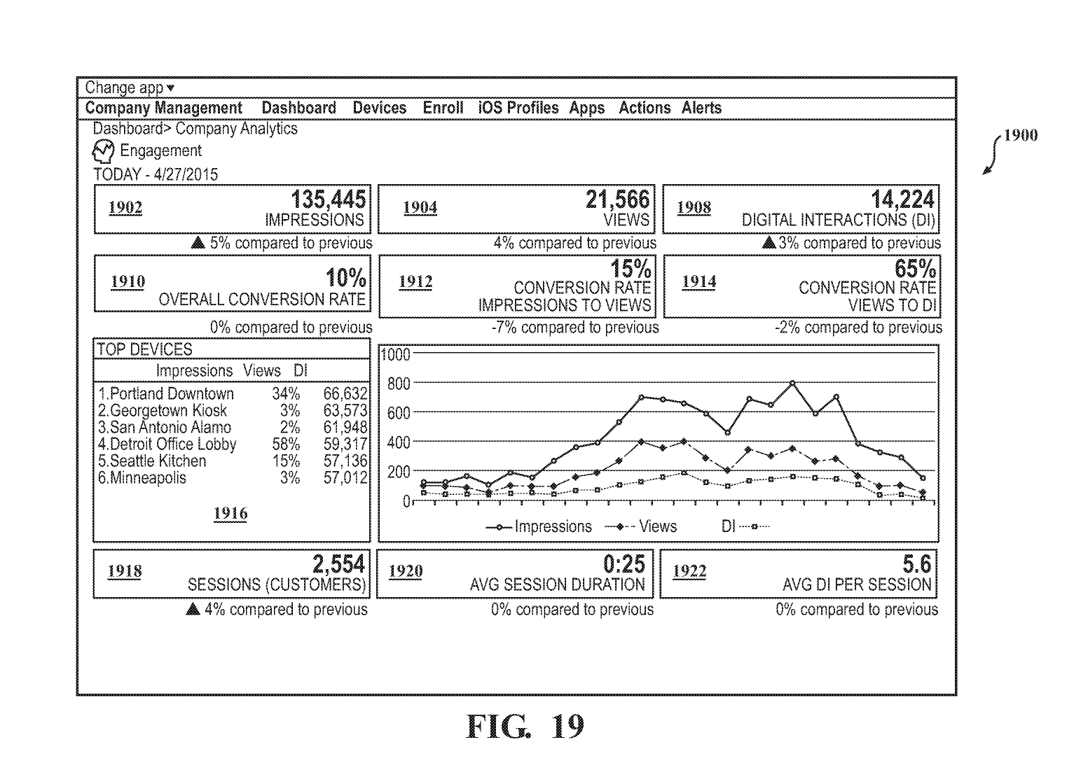

Another dashboard is depicted in FIG. 19. Digital Interaction Tracking Dashboard 1900, displays the aggregated impressions, views and interactions taking place on a purposed device or plurality of purposed devices, and their associated durations and conversion rates presented with graphing of historical usage data. Thus, in FIG. 19, there are displays of impressions 1902, views 1904 and digital interactions 1906 for a particular period of time, e.g., a day, week, two weeks, or other convenient period, along with a comparison to the previous period of time, e.g., up 3, 4 or 5%. The dashboard displays the conversion rate from impressions to digital interactions (overall conversion rate) 1910 as well as the conversion rate from impressions to views 1912 and the conversion rate of view of digital interactions 1914. These conversion rates allow operators or managers to see where improvements can be made. For example, it may be difficult to improve a 65% conversion rate of views to digital interactions; however, there is plenty of room to improve a 15% conversion rate of impressions (passersby) to views.

Dashboard 1900 also includes a listing 1916 and a graphical display of the top-performing single purpose mobile devices. Other displays on the dashboard include the number of sessions 1918, the average session duration 1920 and the average number of digital interactions per session. Other statistics or metrics may be used instead of or in addition to these.

As the person interacts with the purposed device, the PDMP may record activities occurring on the purposed device at the prompting of the user. For example, a user may select to open Application 1 but not Application 2. Once Application 1 is opened, the customer may select from a menu to have men's shirts displayed within the application. Among shirts the user may then select to view only one type of shirt and only in one color. If the person is recognized and known, the PDMP may obtain data relating to the customer's size, for example, and automatically present only items available in the preferred size of the user. All such interactions may be recorded by the PDMP but the DIT and paired with data derived from the purposed devices camera, microphone or other of the data collection means and functionalities of the purposed device. Continuing the example, the microphone of the purposed device may detect a user saying “yes” or “no” as they view certain shirts within the application and the PDMP may then determine the best next action and/or content to present to the user based at least in part on this basis. Once the camera no longer detects the person in the field of vision of the camera, the PDMP may instruct the device to send out an auditory promotional offer as a “last chance” to entice the customer to either continue to engage with the application, make a transaction or take some other wanted action. Once a person has been absent from the camera's field of vision for a defined time duration, the PDMP may instruct the purposed device to close an application, reboot the device or perform some other activity to remove the vestiges of the prior person's interaction with the device and be prepared to start a new session with a new user.

In embodiments, the PDMP, DIT, and DITD systems and methods disclosed herein may be deployed as a cloud-based platform for app distribution, remote app settings management, device configurations, app monitoring and endpoint security monitoring on communication devices. In embodiments, the PDMP, DIT, and DITD systems may support the management of thousands of devices (e.g., per enterprise) comprising features for device management and monitoring that streamline deployment, manage device configurations over-the-air and monitor app performance and connectivity. Management of purposed devices using the PDMP, DIT, and DITD systems, as described herein, may be based at least in part on device information 502, policies (e.g., enterprise policies and protocols) 504, device restrictions 508, device actions 510, or some other device-related characteristic or purpose. Using these features, including but not limited to data relating to application information 602 associated with applications running on a device or plurality of devices, application management protocols 604, supported applications types enabled by the subject devices, the devices managed by the PDMP, DIT, and DITD systems may be remotely locked down, configured, monitored and secured for use as a reliable single-purpose platform for managing a fleet of communication devices.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A method for remotely restricting functionality of a plurality of general purpose mobile devices to an intended purpose using a purposed-device management platform, the method comprising:
registering the plurality of mobile devices with the purposed-device management platform;
uploading an application to the each of the plurality of mobile devices wherein the application conforms to the intended purpose;
at the purposed-device management platform:
determining settings for the mobile device for the application, wherein the settings are based at least in part on the intended purpose; and
monitoring the settings and monitoring usage of the application for conformance to the intended purpose;
if a nonconforming usage occurs, prompting an alert; and
taking an action based on the alert.

2. The method of claim 1, wherein the step of uploading the application to each of the plurality of mobile devices is accomplished with an application settings management (ASM) module that determines the settings for the application on each of the plurality of mobile devices and does not require individual settings for each device of the plurality of mobile devices.

3. The method of claim 1, further comprising monitoring each of the plurality of general purpose mobile devices for at least one of: geolocation; operating system integrity; operation system configuration; application integrity; application configuration; and security of at least one attached peripheral device.

4. The method of claim 1, wherein the settings are applied to a network of the mobile devices.

5. The method of claim 1, wherein the mobile device is selected from the group consisting of a smart phone, a handheld computer, a tablet computer, a pad-type computer and a portable computer.

6. The method of claim 1, wherein the intended purpose is selected from the group consisting of a point of sale terminal function, a kiosk function, a customer service function, a digital signage function, a resource management function, a testing function and an educational function.

7. The method of claim 1, further comprising uploading the application and the settings to a cloud service for downloading by a device that is registered with the purposed-device management platform.

8. The method of claim 1, wherein the action taken is selected from the group consisting of shutting down the application, blocking use of the application, blocking use of another application, alerting a manager of the individual using the mobile device, locking the mobile device, restoring the device to a correct setting, and returning the device to a factory setting or a default setting.

9. A method for remotely restricting functionality of a mobile device to an intended purpose using a purposed-device management platform, the platform comprising a computer having a non-transitory computer readable medium having stored thereon instructions which, when executed by at least one processor of the computer, causes the at least one processor to perform the steps of:
registering the mobile device with the purposed-device management platform;
uploading an application to the mobile device wherein the application conforms to the intended purpose;
determining settings for the mobile device for the application, wherein the settings are based at least in part on the intended purpose;
monitoring the settings and monitoring usage of the application for conformance to the intended purpose;
if a nonconforming usage occurs, prompting an alert; and
taking an action based on the alert.

10. The method of claim 9, wherein the settings are applied to a network of similar purpose mobile devices.

11. The method of claim 9, wherein the mobile device is selected from the group consisting of a smart phone, a handheld computer, a tablet computer, a pad-type computer and a portable computer.

12. The method of claim 9, wherein the intended purpose is selected from the group consisting of a point of sale terminal, a kiosk function, a customer service function, a digital signage function, a resource management function, a testing function and an educational function.

13. The method of claim 9, wherein the action taken is selected from the group consisting of shutting down the application, blocking use of the application, blocking use of another application, alerting a manager of the individual using the mobile device, locking the mobile device, restoring the device to a correct setting, and returning the device to a factory setting or a default setting.

14. A system for operating a network of mobile devices for an intended purpose, the system comprising:
a computer having a processor;
a purposed-device management platform implemented by the computer;
a plurality of mobile devices in communication with the computer via the purposed device management platform, wherein the communication comprises:
registering the mobile device with the purposed device management platform,
uploading an application to the mobile device wherein the application uploaded conforms to the purpose, and
monitoring the usage and settings for conformance to the intended purpose, wherein nonconforming usage or settings prompts an alert to the purposed device management platform.

15. The system of claim 14, wherein each of the plurality of mobile devices further comprises:
an application for digital interaction tracking with a customer or potential customer of an organization operating the purposed device; and
an application for digital interaction tracking with the customer or potential customer of the organization operating the purposed-device management platform.

16. The system of claim 15, wherein the application for digital interaction with the customer or potential customer is adapted for presenting options for a good or a service to the customer or potential customer of the organization operating the purposed-device management platform.

17. The system of claim 15, wherein each of the plurality of mobile devices in communication with the computer via the purposed-device management platform further comprises a digital camera for capturing an image of the customer or potential customer and facial recognition software for interpreting the image of the customer or potential customer.

18. The system of claim 17, wherein the application for digital interaction tracking with the customer or potential customer and the facial recognition software are adapted for recognizing a facial image of the customer or potential customer, a length of time the customer or potential customer faces the digital camera, a touching of a feature of one of the plurality of mobile devices and an interpretation of interest or non-interest by the customer or potential customer.

19. The system of claim 14, wherein the application for digital interaction tracking is adapted automatically tabulate a quantity of interactive sessions with customers or potential customers of the organization operating the purposed-device management platform.

20. The system of claim 14 wherein the application for digital interaction tracking is adapted to automatically tabulate a quantity of impressions with customers or potential customers, a quantity of views from the customers or potential customers with impressions, a conversion rate of the quantity of impressions to the quantity of views, a quantity of digital interactions with customers or potential customers with views and a conversion rate of the quantity of views to the quantity of digital interactions.
